(19) United States
(12) Patent Application Publication
(10) Pub. No.: US 2014/0279431 A1
(43) Pub. Date: Sep. 18, 2014

(54) DEVICES, METHODS, AND SYSTEMS FOR ACCEPTING MULTIPLE NONUNIFORM INPUT CHANNELS

(71) Applicant: Elwha LLC, Bellevue, WA (US)

(72) Inventors: Pablos Holman, Seattle, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US)

(73) Assignee: Elwha LLC, a limited company of the State of Delaware

(21) Appl. No.: 13/964,668

(22) Filed: Aug. 12, 2013

Related U.S. Application Data
(63) Continuation of application No. 13/964,580, filed on Aug. 12, 2013.
Application No. 13/964,580 is a continuation-in-part of application No. 13/843,118, filed on Mar. 15, 2013.
Application No. 13/843,118 is a continuation-in-part of application No. 13/907,565, filed on May 31, 2013.
Application No. 13/907,565 is a continuation-in-part of application No. 13/907,627, filed on May 31, 2013.
Application No. 13/907,627 is a continuation-in-part of application No. 13/932,914, filed on Jul. 1, 2013.
Application No. 13/932,914 is a continuation-in-part of application No. 13/932,991, filed on Jul. 1, 2013.
Application No. 13/932,991 is a continuation-in-part of application No. 13/932,918, filed on Jul. 1, 2013.
Application No. 13/932,918 is a continuation-in-part of application No. 13/932,993, filed on Jul. 1, 2013.
Application No. 13/932,993 is a continuation-in-part of application No. 13/934,134, filed on Jul. 2, 2013.
Application No. 13/934,134 is a continuation-in-part of application No. 13/934,139, filed on Jul. 2, 2013.

(51) Int. Cl. G06Q 20/10

(52) U.S. Cl. CPC G06Q 20/10
USPC 705/39

(57) ABSTRACT

Computationally implemented methods and systems include receiving a potential transaction initiation request, said potential transaction initiation request configured to indicate an intent to carry out a potential transaction, acquiring potential transaction data that includes a request to use a particular payment channel for at least a portion of the potential transaction, and determining that the acquired particular payment channel includes a payment channel that is not directly accepted. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 13/843,118, entitled METHODS AND SYSTEMS FOR IMPLEMENTING VARIOUS TRANSACTIONAL ARCHITECTURES, naming Pablos Holman, Roderick A. Hyde, Royce A. Levien, Richard T. Lord, Robert W. Lord, and Mark A. Malamud as inventors, filed 15 Mar. 2013 with attorney docket no. 0213-003-001-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/907,565, entitled METHODS AND SYSTEMS FOR AGNOSTIC PAYMENT SYSTEMS, naming Pablos Holman, Roderick A. Hyde, Royce A. Levien, Richard T. Lord, Robert W. Lord, and Mark A. Malamud as inventors, filed 31 May 2013 with attorney docket no. 0213-003-002-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/907,627, entitled METHODS AND SYSTEMS FOR AGNOSTIC PAYMENT SYSTEMS, naming Pablos Holman, Roderick A. Hyde, Royce A. Levien, Richard T. Lord, Robert W. Lord, and Mark A. Malamud as inventors, filed 31 May 2013 with attorney docket no. 0213-003-045-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,914, entitled METHODS, SYSTEMS, AND DEVICES FOR HANDLING MULTIPLE DISPARATE SYSTEMS, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-003-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,991, entitled METHODS, SYSTEMS, AND DEVICES FOR HANDLING MULTIPLE DISPARATE SYSTEMS, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-046-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,918, entitled DEVICES, METHODS, AND SYSTEMS FOR TECHNOLOGICALLY SHIFTING OPTIONS AND MODALITIES, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-004-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/932,993, entitled DEVICES, METHODS, AND SYSTEMS FOR TECHNOLOGICALLY SHIFTING OPTIONS AND MODALITIES, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-047-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/934,134, entitled DEVICES, METHODS, AND SYSTEMS FOR ADAPTING CHANNEL PREFERENCES FOR A CLIENT, naming Pablos Holman, Roderick A. Hyde, Royce A. Levien, Richard T. Lord, Robert W. Lord, and Mark A. Malamud as inventors, filed 2 Jul. 2013 with attorney docket no. 0213-003-005-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/934,139, entitled DEVICES, METHODS, AND SYSTEMS FOR ADAPTING CHANNEL PREFERENCES FOR A CLIENT, naming Pablos Holman, Roderick A. Hyde, Royce A. Levien, Richard T. Lord, Robert W. Lord, and Mark A. Malamud as inventors, filed 2 Jul. 2013 with attorney docket no. 0213-003-048-000000, which is currently co-pending or is an application of which a currently co-pending application is entitled to the benefit of the filing date.

### RELATED APPLICATIONS

U.S. patent application Ser. No. ______, entitled DEVICES, METHODS, AND SYSTEMS FOR ASSISTING MULTIPLE DISCRETE DEVICES, naming Pablos Holman, Roderick A. Hyde, Royce A. Levien, Richard T. Lord, Robert W. Lord, and Mark A. Malamud as inventors, filed 12 Aug. 2013 with attorney docket no. 0213-003-007-000000, is related to the present application.

U.S. patent application Ser. No. ______, entitled DEVICES, METHODS, AND SYSTEMS FOR ASSISTING MULTIPLE DISCRETE DEVICES, naming Pablos Holman, Roderick A. Hyde, Royce A. Levien, Richard T. Lord, Robert W. Lord, and Mark A. Malamud as inventors, filed 12 Aug. 2013 with attorney docket no. 0213-003-050-000000, is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to data services.

### SUMMARY

In one or more various aspects, a method includes but is not limited to receiving a potential transaction initiation request, said potential transaction initiation request configured to indicate an intent to carry out a potential transaction, acquiring potential transaction data that includes a request to use a particular payment channel for at least a portion of the potential transaction, determining that the acquired particular payment channel includes a payment channel that is not directly accepted, and negotiating a payment channel facilitation configured to facilitate at least a portion of the potential transaction in a manner in which, to at least one party to the potential transaction, the acquired payment channel appears to be used to carry out the potential transaction. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for receiving a potential transaction initiation request, said potential transaction initiation request configured to indicate an intent to carry out a potential transaction, means for acquiring potential transaction data that includes a request to use a particular payment channel for at least a portion of the potential transaction, means for determining that the acquired particular payment channel includes a payment channel that is not directly accepted, and means for negotiating a payment channel facilitation configured to facilitate at least a portion of the potential transaction in a manner in which, to at least one party to the potential transaction, the acquired payment channel appears to be used to carry out the potential transaction. In addition to the foregoing, other system aspects are described in the claims, drawings, and text forming a part of the disclosure set forth herein.

In one or more various aspects, a system includes, but is not limited to, circuitry for receiving a potential transaction initiation request, said potential transaction initiation request configured to indicate an intent to carry out a potential transaction, circuitry for acquiring potential transaction data that includes a request to use a particular payment channel for at least a portion of the potential transaction, circuitry for determining that the acquired particular payment channel includes a payment channel that is not directly accepted, and negotiating a payment channel facilitation configured to facilitate at least a portion of the potential transaction in a manner in which, to at least one party to the potential transaction, the acquired payment channel appears to be used to carry out the potential transaction. In addition to the foregoing, other system aspects are described in the claims, drawings, and text forming a part of the disclosure set forth herein.

In one or more various aspects, a computer program product, comprising a signal bearing medium, bearing one or more instructions including, but not limited to, one or more instructions for receiving a potential transaction initiation request, said potential transaction initiation request configured to indicate an intent to carry out a potential transaction, one or more instructions for acquiring potential transaction data that includes a request to use a particular payment channel for at least a portion of the potential transaction, one or more instructions for determining that the acquired particular payment channel includes a payment channel that is not directly accepted, and one or more instructions for negotiating a payment channel facilitation configured to facilitate at least a portion of the potential transaction in a manner in which, to at least one party to the potential transaction, the acquired payment channel appears to be used to carry out the potential transaction. In addition to the foregoing, other computer program product aspects are described in the claims, drawings, and text forming a part of the disclosure set forth herein.

In one or more various aspects, a device is defined by a computational language, such that the device comprises one or more interchained physical machines ordered for receiving a potential transaction initiation request, said potential transaction initiation request configured to indicate an intent to carry out a potential transaction, one or more interchained physical machines ordered for acquiring potential transaction data that includes a request to use a particular payment channel for at least a portion of the potential transaction, one or more interchained physical machines ordered for determining that the acquired particular payment channel includes a payment channel that is not directly accepted, and one or more interchained physical machines ordered for negotiating a payment channel facilitation configured to facilitate at least a portion of the potential transaction in a manner in which, to at least one party to the potential transaction, the acquired payment channel appears to be used to carry out the potential transaction.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1A-1AI, shows a high-level system diagram of one or more exemplary environments in which transactions and potential transactions may be carried out, according to one or more embodiments. FIG. 1 forms a partially schematic diagram of an environment(s) and/or an implementation(s) of technologies described herein when FIGS. 1A-1AI are stitched together in the manner shown in FIG. 1E, which is reproduced below in table format.

TABLE 1
Table showing alignment of enclosed drawings to form partial schematic of one
or more environments.

| | | | | |
|---|---|---|---|---|
| (1, 1) - FIG. 1A | (1, 2) - FIG. 1B | (1, 3) - FIG. 1C | (1, 4) - FIG. 1D | (1, 5) - FIG. 1E |
| (2, 1) - FIG. 1F | (2, 2) - FIG. 1G | (2, 3) - FIG. 1H | (2, 4) - FIG. 1I | (2, 5) - FIG. 1J |
| (3, 1) - FIG. 1K | (3, 2) - FIG. 1L | (3, 3) - FIG. 1M | (3, 4) - FIG. 1N | (3, 5) - FIG. 1O |
| (4, 1) - FIG. 1P | (4, 2) - FIG. 1Q | (4, 3) - FIG. 1R | (4, 4) - FIG. 1S | (4, 5) - FIG. 1T |
| (5, 1) - FIG. 1U | (5, 2) - FIG. 1V | (5, 3) - FIG. 1W | (5, 4) - FIG. 1X | (5, 5) - FIG. 1Y |
| (6, 1) - FIG. 1Z | (6, 2) - FIG. 1AA | (6, 3) - FIG. 1AB | (6, 4) - FIG. 1AC | (6, 5) - FIG. 1AD |
| (7, 1) - FIG. 1AE | (7, 2) - FIG. 1AF | (7, 3) - FIG. 1AG | (7, 4) - FIG. 1AH | (7, 5) - FIG. 1AI |

FIG. 1A, when placed at position (1,1), forms at least a portion of a partially schematic diagram of an environment(s) and/or an implementation(s) of technologies described herein.

FIG. 1B, when placed at position (1,2), forms at least a portion of a partially schematic diagram of an environment(s) and/or an implementation(s) of technologies described herein.

FIG. 1C, when placed at position (1,3), forms at least a portion of a partially schematic diagram of an environment(s) and/or an implementation(s) of technologies described herein.

FIG. 1D, when placed at position (1,4), forms at least a portion of a partially schematic diagram of an environment(s) and/or an implementation(s) of technologies described herein.

FIG. 1E, when placed at position (1,5), forms at least a portion of a partially schematic diagram of an environment(s) and/or an implementation(s) of technologies described herein.

FIG. 1F, when placed at position (2,1), forms at least a portion of a partially schematic diagram of an environment(s) and/or an implementation(s) of technologies described herein.

FIG. 1G, when placed at position (2,2), forms at least a portion of a partially schematic diagram of an environment(s) and/or an implementation(s) of technologies described herein.

FIG. 1H, when placed at position (2,3), forms at least a portion of a partially schematic diagram of an environment(s) and/or an implementation(s) of technologies described herein.

FIG. 1I, when placed at position (2,4), forms at least a portion of a partially schematic diagram of an environment(s) and/or an implementation(s) of technologies described herein.

FIG. 1J, when placed at position (2,5), forms at least a portion of a partially schematic diagram of an environment(s) and/or an implementation(s) of technologies described herein.

FIG. 1K, when placed at position (3,1), forms at least a portion of a partially schematic diagram of an environment(s) and/or an implementation(s) of technologies described herein.

FIG. 1L, when placed at position (3,2), forms at least a portion of a partially schematic diagram of an environment(s) and/or an implementation(s) of technologies described herein.

FIG. 1M, when placed at position (3,3), forms at least a portion of a partially schematic diagram of an environment(s) and/or an implementation(s) of technologies described herein.

FIG. 1N, when placed at position (3,4), forms at least a portion of a partially schematic diagram of an environment(s) and/or an implementation(s) of technologies described herein.

FIG. 1O, when placed at position (3,5), forms at least a portion of a partially schematic diagram of an environment(s) and/or an implementation(s) of technologies described herein.

FIG. 1P, when placed at position (4,1), forms at least a portion of a partially schematic diagram of an environment(s) and/or an implementation(s) of technologies described herein.

FIG. 1Q, when placed at position (4,2), forms at least a portion of a partially schematic diagram of an environment(s) and/or an implementation(s) of technologies described herein.

FIG. 1R, when placed at position (4,3), forms at least a portion of a partially schematic diagram of an environment(s) and/or an implementation(s) of technologies described herein.

FIG. 1S, when placed at position (4,4), forms at least a portion of a partially schematic diagram of an environment(s) and/or an implementation(s) of technologies described herein.

FIG. 1T, when placed at position (4,5), forms at least a portion of a partially schematic diagram of an environment(s) and/or an implementation(s) of technologies described herein.

FIG. 1U, when placed at position (5,1), forms at least a portion of a partially schematic diagram of an environment(s) and/or an implementation(s) of technologies described herein.

FIG. 1V, when placed at position (5,2), forms at least a portion of a partially schematic diagram of an environment(s) and/or an implementation(s) of technologies described herein.

FIG. 1W, when placed at position (5,3), forms at least a portion of a partially schematic diagram of an environment(s) and/or an implementation(s) of technologies described herein.

FIG. 1X, when placed at position (5,4), forms at least a portion of a partially schematic diagram of an environment(s) and/or an implementation(s) of technologies described herein.

FIG. 1Y, when placed at position (5,5), forms at least a portion of a partially schematic diagram of an environment(s) and/or an implementation(s) of technologies described herein.

FIG. 1Z, when placed at position (6,1), forms at least a portion of a partially schematic diagram of an environment(s) and/or an implementation(s) of technologies described herein.

FIG. 1AA, when placed at position (6,2), forms at least a portion of a partially schematic diagram of an environment(s) and/or an implementation(s) of technologies described herein.

FIG. 1AB, when placed at position (6,3), forms at least a portion of a partially schematic diagram of an environment(s) and/or an implementation(s) of technologies described herein.

FIG. 1AC, when placed at position (6,4), forms at least a portion of a partially schematic diagram of an environment(s) and/or an implementation(s) of technologies described herein.

FIG. 1AD, when placed at position (6,5), forms at least a portion of a partially schematic diagram of an environment(s) and/or an implementation(s) of technologies described herein.

FIG. 1AE, when placed at position (7,1), forms at least a portion of a partially schematic diagram of an environment(s) and/or an implementation(s) of technologies described herein.

FIG. 1AF, when placed at position (7,2), forms at least a portion of a partially schematic diagram of an environment(s) and/or an implementation(s) of technologies described herein.

FIG. 1AG, when placed at position (7,3), forms at least a portion of a partially schematic diagram of an environment(s) and/or an implementation(s) of technologies described herein.

FIG. 1AH, when placed at position (7,4), forms at least a portion of a partially schematic diagram of an environment(s) and/or an implementation(s) of technologies described herein.

FIG. 1AI, when placed at position (7,5), forms at least a portion of a partially schematic diagram of an environment(s) and/or an implementation(s) of technologies described herein.

FIG. 2A shows a high-level block diagram of an exemplary environment 200, according to one or more embodiments.

FIG. 2B shows a high-level block diagram of a device 280 operating in an exemplary environment 200, according to one or more embodiments.

FIG. 3, including FIGS. 3A-3D, shows a particular perspective of a request for potential transaction initiation including indicator of intent to carry out potential transaction receiving module 252 of processing module 250 of device 280 of FIG. 2B, according to an embodiment.

FIG. 4, including FIGS. 4A-4C, shows a particular perspective of a transaction data including request to utilize a particular payment channel for carrying out at least a portion of the potential transaction acquiring module 254 of device 280 of personal device 220 of FIG. 2B, according to an embodiment.

FIG. 5, including FIGS. 5A-5C, shows a particular perspective of a acquired particular payment channel absence from a set of one or more directly accepted payment channels determining module 256 of processing module 250 of device 280 of FIG. 2B, according to an embodiment.

FIG. 6, including FIGS. 6A-6H, shows a particular perspective of an facilitation of at least a portion of the potential transaction configured to provide an appearance of using the acquired payment channel to at least one party to the potential transaction negotiating module 258 of processing module 250 of device 280 of FIG. 2B, according to an embodiment.

FIG. 7 is a high-level logic flowchart of a process, e.g., operational flow 700, according to an embodiment.

FIG. 8A is a high-level logic flow chart of a process depicting alternate implementations of a receiving a potential transaction initiation request operation 702, according to one or more embodiments.

FIG. 8B is a high-level logic flow chart of a process depicting alternate implementations of a receiving a potential transaction initiation request operation 702, according to one or more embodiments.

FIG. 8C is a high-level logic flow chart of a process depicting alternate implementations of a receiving a potential transaction initiation request operation 702, according to one or more embodiments.

FIG. 8D is a high-level logic flow chart of a process depicting alternate implementations of a receiving a potential transaction initiation request operation 702, according to one or more embodiments.

FIG. 9A is a high-level logic flow chart of a process depicting alternate implementations of an acquiring potential transaction data operation 704, according to one or more embodiments.

FIG. 9B is a high-level logic flow chart of a process depicting alternate implementations of an acquiring potential transaction data operation 704, according to one or more embodiments.

FIG. 9C is a high-level logic flow chart of a process depicting alternate implementations of an acquiring potential transaction data operation 704, according to one or more embodiments.

FIG. 10A is a high-level logic flow chart of a process depicting alternate implementations of a determining that the acquired particular payment channel includes a payment channel that is not directly accepted operation 706, according to one or more embodiments.

FIG. 10B is a high-level logic flow chart of a process depicting alternate implementations of a determining that the acquired particular payment channel includes a payment channel that is not directly accepted operation 706, according to one or more embodiments.

FIG. 10C is a high-level logic flow chart of a process depicting alternate implementations of a determining that the acquired particular payment channel includes a payment channel that is not directly accepted operation 706, according to one or more embodiments.

FIG. 11A is a high-level logic flow chart of a process depicting alternate implementations of a negotiating a payment channel facilitation operation 708, according to one or more embodiments.

FIG. 11B is a high-level logic flow chart of a process depicting alternate implementations of a negotiating a payment channel facilitation operation 708, according to one or more embodiments.

FIG. 11C is a high-level logic flow chart of a process depicting alternate implementations of a negotiating a payment channel facilitation operation 708, according to one or more embodiments.

FIG. 11D is a high-level logic flow chart of a process depicting alternate implementations of a negotiating a payment channel facilitation operation 708, according to one or more embodiments.

FIG. 11E is a high-level logic flow chart of a process depicting alternate implementations of a negotiating a payment channel facilitation operation 708, according to one or more embodiments.

FIG. 11F is a high-level logic flow chart of a process depicting alternate implementations of a negotiating a payment channel facilitation operation 708, according to one or more embodiments.

FIG. 11G is a high-level logic flow chart of a process depicting alternate implementations of a negotiating a payment channel facilitation operation 708, according to one or more embodiments.

FIG. 11H is a high-level logic flow chart of a process depicting alternate implementations of a negotiating a payment channel facilitation operation 708, according to one or more embodiments.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for receiving a potential transaction initiation request, said potential transaction initiation request configured to indicate an intent to carry out a potential transaction, acquiring potential transaction data that includes a request to use a particular payment channel for at least a portion of the potential transaction, determining that the acquired particular payment channel includes a payment channel that is not directly accepted, and negotiating a payment channel facilitation configured to facilitate at least a portion of the potential transaction in a manner in which, to at least one party to the potential transaction, the acquired payment channel appears to be used to carry out the potential transaction.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although user 105 is shown/described herein, e.g., in FIG. 1, and other places, as a single illustrated figure, those skilled in the art will appreciate that user 105 may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

In known systems, vendors offer payment channels for completing transactions. In known systems, users have payment channels that they want to use to carry out transactions. Sometimes, a user payment channel may be different than a vendor payment channel. For example, a user may not have her credit card present on her person, but may have her smartphone. The vendor may only accept credit card swipe with signature.

In an embodiment, the user device may manage payment channels for a user, so that when the vendor supplies a set of possible vendor payment channels, the user may select one or more of the payment channels based on one or more user preferences.

This application uses the words “user” and “client” interchangeably, to further underscore the intention that “user” may not necessarily be a person, but any entity that has a relationship with the vendor. The use of the word “client” does not impute any relationship between the entity and the vendor other than the potential for an exchange of goods and/or services for compensation between the client and the vendor.

Referring now to FIG. 1, FIG. 1 illustrates an exemplary system environment in which one or more methods, systems, circuitry, articles of manufacture, and computer program products and architecture, in accordance with various embodiments, may interoperate. FIG. 1 may show one or more systems that may operate in coordination or independently. One or more portions of systems in FIG. 1 may operate as a complete system, or as a component of a larger system.

Referring now to FIG. 1, FIG. 1 shows a payment initiation module 2210. The payment initiation module may be part of user device 120, or may be a separate device. Payment initiation module 2210 may be any module that detects a user's intention to carry out one or more transaction. The detection of a user's intention to carry out one or more transactions may be relayed from another device, may be inferred, directly or indirectly, from user input, may be inferred from user action (e.g., a user places an item in a shopping cart, or pours a cup of coffee, or takes a bottle of wine off of a shelf), may be initiated by a person that is observing the user or otherwise interacting with the user (e.g., a barista at a coffee shop, or a technician in a mobile device store). In an embodiment, this module may be designed to provide the user with a seamless interface, e.g., the displaying of a “pay now” button, which will be described in more detail herein with respect to the “context sensitive pay button branch” observable extending to the left of payment initiation module 2210 in the context of FIG. 1. It is noted that the direction here and in other places throughout FIG. 1 was chosen merely for illustrative purposes and has no bearing or effect on the operation of the various modules and/or components of FIG. 1.

Referring again to FIG. 1, in an embodiment, payment initiation module 2210 may include payment initiation exemplary module 2210A, which is illustrated as a module that is designed to carry out an exemplary, non-limiting example embodiment, specifically, that a user desires to pay for an item that the user has selected at a store. In an example, the user has selected a bottle of wine, for which the user desires to pay. In this example, the user is in a wine store, but in another example, the store could be virtual, and the user could be in their home or at another location browsing a virtual store on a computer, tablet, mobile phone, or other device.

In an embodiment, payment initiation module 2210 may include simple payment initiation module that may initiate a simplified payment branching module, in which a user wants to pay for an item, or determine how much an item costs, or determine whether there is enough money (e.g., cash or cash equivalents, e.g., points, rewards, rebates, coupons, tokens, etc.) in one or more accounts e.g., an item the user has taken a picture of, or placed in a cart, or grabbed, or poured, e.g., coffee in a coffee shop or soda out of a soda dispenser, and the action initiates payment, or a negotiation for payment, for the item or service. In an embodiment, a user may be wearing augmented reality glasses, and may look at an item and make some sort of hand, eye, or bodily gesture (e.g., waving the hand across the face), or speak a particular command or set of words, that indicates that the user desires to pay for an item. In an embodiment, the payment initiation may be a time based event, e.g., the start of a movie, if a user has gotten concessions from an usher or a popcorn stand, or the like, or the start of a round or an inning of a sporting event, e.g., a baseball game. In an embodiment, the details of the payment channel negotiation, either for modality, option, or both, may be hidden from the user as the completion of a transaction. In an embodiment, there may be a fixed system, e.g., a user may go to a video arcade, and receive twenty tokens worth of credits, and the simple payment initiation occurs each time the user performs an action that debits a token, until the tokens are expended.

In an embodiment, a user may be placed in an environment where the user is allowed to select multiple items, products, or services, up to a limit, which may be time, credit, money, or token-based, e.g., a buffet, or a payment for five minutes in an electronics store, or a payment that allows a user to select twenty different resistors from a bin at an electronics store, e.g., a Radio Shack. In such an embodiment, the payment initiation module may handle the negotiation of payment and alert the user when the limit has been reached.

In an embodiment, the details of how the payment is negotiated are hidden from the user. For example, the manner in which the vendor acquires payment, e.g., whether over a Wi-Fi network, or the equivalent scanning of a bar code, or the entry of a PIN number, may be obscured from the user, who may receive simplified information indicating the success or failure of the transaction, or, in an embodiment, less information than that.

In an embodiment, as shown in FIG. 1, payment branching may lead to one or more portions of a user device 120 (e.g., following the red arrow “south” or “downward”). User device 120 may include, among other elements, a device memory 126. Device memory 126 may store one or more of a user payment option set and a user payment modality set.

In an embodiment, “payment” may refer to any portion of a transaction between a user and a vendor, including the selection and/or identification of an item and/or a service. As a tangible example, the scanning of a barcode on a can of peaches at a grocery store may be part of the “payment.” As another example, a barista keying in a description of a coffee order from a user into a computing device may also be part of a “payment.” Payment may also include authentication of a user to determine a user is the entity that the user is claiming to be. Payment is used merely as a convenient shorthand to refer to the entire process from start to finish of the acquisition of one or more goods and/or services by a user, and is not intended to be limited to the point of the transaction in which money and/or money equivalents change possession from the user to the vendor.

Under the terminology of this application, “payment modality” may refer to the mechanic by which payment information is exchanged between the vendor and the user. “Payment option” refers to the type of payment utilized by the user, and may refer to a type of credit card, a type of debit card, a type of electronic currency, and the like. The term “payment channel” may refer to one or both of “payment modality” and “payment option.”

Referring again to FIG. 1, FIG. 1 shows exemplary payment options 2120. Exemplary payment options 2120 are not intended to be an exhaustive list, but merely exemplary of some of the various types of payment options. For example, exemplary payment options 2120 may include one or more of credit card A 2122 (e.g., which may be a credit card that includes travel rewards, e.g., discounts on travel expenses), credit card B 2124 (e.g., which may be a card that accumulates fuel purchasing rewards, e.g., discounts on gasoline expenses), personal debit card 2126, corporate credit card 2128, PayPal account 2132, frequent shopper rewards card 2134, gift certificate 2136 and 2137 (e.g., which could refer to a specific gift certificate, e.g., “ten dollar Starbucks card” that can be redeemed only at a particular vendor, or a generic gift certificate, e.g., an “American Express gift card,” that is valid and redeemable regardless of the vendor, or a combination of the two (e.g., a gift card good at any hardware store, or any store in the downtown area of a city), instant credit approval 2138, cash 2142, foreign currency 2144, and cash equivalents 2146.

Referring again to FIG. 1, FIG. 1 shows exemplary payment modalities 2320. Exemplary payment modalities 2320 are not intended to be an exhaustive list, but merely exemplary of some of the various types of payment modalities. For example, exemplary payment modalities 2320 may include one or more of virtual currency (e.g., BitCoins, or Xbox points, and the like), one-dimensional (1-D) barcode scan 2358, credit card with swipe only 2322, credit card with swipe and personal identification number (PIN) entry 2324, biometric retinal scan 2339, biometric fingerprint scan 2342, two-dimensional (2-D) barcode scan 2356, color barcode scan 2362, credit card with swipe and signature 2325, device tap, e.g., near field communication technology 2332, audio speech recognition (e.g., identifying the words that are spoken) 2344, audio voice recognition (e.g., identifying the speaker that has spoken, e.g., voiceprint analysis, or other voice identification techniques, PIN and/or password only 2352, trusted device voucher 2354, device authentication over a wireless network 2334, device authentication over a cellular network 2336, credit card proximity (e.g., via Radio-Frequency Identification (RFID)) 2326, credit card microchip 2364, electronic funds transfer 2368, device proxy 2348 (e.g., where another, more complex device performs one or more steps in completing the payment process), and three-dimensional object identification 2372.

As shown in FIG. 1, exemplary payment options 2120 and exemplary payment modalities 2320 are illustrated as “clouds” in the drawings. This is to indicate that the payment options and the payment modalities can be substituted anywhere in the system without substantially changing the system. Specific examples may be given with specific payment options and payment modalities, but substitution with other options and/or modalities, whether listed as exemplary in this application or not listed, will not substantially change the operation of this architecture and should be considered as within the scope of this invention.

Referring again to FIG. 1, user device 120 may include user payment channel obtaining module 2240. User payment channel obtaining module 2240 may obtain the various user payment channels through one or more techniques, whether retrieving from device memory, scanning the device, polling different portions of the device, receiving and/or retrieving data from a remote location, or a combination of these. Payment channel obtaining module 2240 also may be dynamic, e.g., may determine that Wi-Fi is not available as a payment modality if there is no available open wireless network. Similarly, a user may disable various modalities, e.g., a user may want to stop using Credit Card A at a particular time, for example, if the user is approaching a credit limit. Payment channel obtaining module 2240 may include one or more of user payment option set obtaining module 2220 and user payment modality set obtaining module 2230. User payment option set obtaining module 2220 may be configured to obtain the payment option set for that user under a particular set of conditions, or generally. Similarly, user payment modality set obtaining module 2230 may be configured to obtain the payment modality set for that user under a particular set of conditions, or generally.

In an embodiment, user payment option set obtaining module 2220 may include user payment option set receiving module 2222. User payment option set receiving module 2222 may receive a user payment option set from a location. In an embodiment, the user payment option set, e.g., an exemplary user payment option set 3010A, may be received from cloud storage, e.g., network storage, e.g., user payment channel set cloud storage module 3010. User payment channel set cloud storage module 3010 may be any form of storage that is remote to user device 120, regardless of the owner of the network space, or the characteristics of the space, e.g., shared, dedicated, specific, and the like.

In an embodiment, user payment option set receiving module 2222 may receive a user payment option set, e.g., exemplary user payment option set 3020B, from a user payment channel set home/enterprise server storage module 3020. Module 3020 may be a home server, for example, or may be a related device to a device carried by a user. For example, user device 120 may be a watch, or a pair of glasses, that provides functionality to a user, whereas a payment option set is stored on a phone device carried by the user, or on a phone device carried by a related user, e.g., a user's mother, classroom teacher, boss, and the like.

In an embodiment, user payment channel obtaining module 2240 may include one or more of user payment option set receiving module 2222, user payment option set retrieving module 2224, and user payment option set generating module 2226. In an embodiment, user payment modality set obtaining module 2230 may include user payment modality set receiving module 2232, user payment modality set retrieving module 2234, and user payment modality set 2236. In an embodiment, one or more of these modules may work together to obtain one or more of the user payment option set and the user payment modality set. It is noted here that “set” may include a set of one payment option, or a set of one payment modality, or an empty set (e.g., there are no available payment options under the current conditions). It is further noted that “set” implies any structure, e.g., data structure, capable of representing, storing, manipulating, transmitting, conveying, displaying, or otherwise acting upon or for data.

In an embodiment, the user payment channel obtaining module 2240 obtains the user payment channel. Referring again to FIG. 1, as an example, the obtained user payment channel set, e.g., obtained user payment channel 2260, may include user payment option set 2262 and user payment modality set 2264. It is noted that these are merely exemplary user payment option sets and user payment modality sets, and other embodiments may include other sets of various size and content. Also, although the user payment option set 2262 and the user payment modality set 2264 are illustrated separately, this is merely for ease of understanding and illustration. In an embodiment, there may be a single set that includes part or all of a user payment option set and a user payment modality set, or multiple sets that contain one or more portions of one or more of the user payment option set and the user payment modality set.

In an embodiment, the obtained user payment channel set 2260 may include user payment option set 2262. As an example, and merely for the purposes of illustration, user payment option set 2262 may include credit card A 2122 and personal debit card 2126. In an embodiment, the obtained user payment channel set 2260 may include user payment modality set 2264. As an example, and merely for the purposes of illustration, user payment modality set 2264 may include device tap near-field communication 2332 and audio-voice 2346.

In an embodiment, user device 120 also may include vendor payment channel obtaining module 2410. Although pictured as part of user device 120, this is merely for illustrative purposes. In another embodiment, user device 120 may be external to user device 120, or may communicate over any form of network or any other form of communication. Moreover, vendor payment channel obtaining module 2410 may be interpreted in the illustration as operating after user payment channel obtaining module 2240. In an embodiment, vendor payment channel obtaining module 2410 may operate after user payment channel obtaining module 2240. In other embodiments, vendor payment channel obtaining module 2410 may operate concurrently or before, or on a different thread, processor, device, or system, as user payment channel obtaining module 2240.

In an embodiment, vendor payment channel obtaining module 2410 may include a vendor interface module 2412. Vendor interface module 2412 may be configured to receive a transmission of one or more vendor payment options and/or one or more vendor payment modalities. For example, in an embodiment, vendor interface module 2412 receives a broadcast from vendor device 6100, e.g., vendor payment channel set broadcasting module 2612. In an embodiment, vendor interface module 2412 may include vendor payment option set 2462 and vendor payment modality set 2464.

In an embodiment, vendor payment channel obtaining module 2410 may include vendor interface retrieving module 2414. Vendor interface retrieving module 2414 may retrieve one or more portions of one or more of the vendor payment option set, e.g., vendor payment option set 2462, and vendor payment modality set 2464. In an embodiment, vendor interface retrieving module 2414 may include vendor interface retrieving from vendor module 2416 and vendor interface retrieving from trusted device module 2418. In an embodiment, vendor payment channel obtaining module 2410 may include one or more of vendor payment channel determining module 2422 and vendor payment channel detecting module 2422.

In an embodiment, vendor payment channel obtaining module 2410 may include vendor scanning module 2430. In an embodiment, vendor scanning module 2430 may be configured to use one or more tools, e.g., hardware, software, or a combination thereof, to scan the surroundings of the user device 120, or to scan related networks for information about the surroundings of user device 120, in order to obtain information about one or more vendor payment channel sets. For example, vendor scanning module may acquire information through various forms, as indicated in module 2430A. For example, the user device may acquire data about vendor payment channels from one or more trusted devices, one or more devices in the proximity that are sharing or willing to share data, through Internet network resources (e.g., social networks, e.g., Twitter, Facebook, and the like), through one or more specific databases that may be proprietary and may be provided by one or more manufacturers of devices and/or device operating systems, e.g., Apple, Inc.

In an embodiment, module 2430 may include one or more databases which may be read by vendor scanning module 2430. With respect to module 2430, the “database” may be replaced with any data structure, or may represent data that is scattered across one or more networks and collected by one or more services, which may or may not be acting under the direction of user device 120. For example, module 2430 may include vendor information proprietary database 2431A, vendor information from search engine/data repository 2431B, vendor information from polling/querying area devices 2431C, vendor information from polling/querying trusted devices 2431D, and vendor information from publicly available data 2431E. In an embodiment, one or more of these or other sources may be used to obtain a vendor payment option set and/or a vendor payment modality set.

In an embodiment, vendor payment channel obtaining module 2410 may obtain one or more vendor payment channel sets 2460. In an embodiment, and for exemplary and/or illustrative purposes only, vendor payment channel set 2460 may include vendor payment option set 2462 and/or vendor payment modality set 2464. In an embodiment, and only for exemplary purposes, vendor payment option set 2462 may include credit card A 2122 and cash 2142. In an embodiment, and only for exemplary purposes, vendor payment modality set 2464 may include credit card swipe+PIN 2324 and credit card swipe+signature 2325. In an embodiment, this information may be gathered by vendor scanning module 2430, which, in an embodiment, may query the vendor's network to determine which modalities of payment are recognized. In an embodiment, the vendor scanning module 2430 may use false data to sample the systems of the vendor, to determine what capabilities for modalities and payment options are possessed by the vendor.

In an embodiment, when the user payment channel sets (e.g., user payment channel set 2260) and the vendor payment channel sets (e.g., vendor payment channel set 2460) have been obtained, then, in an embodiment, payment option comparator module 2500 and payment modality comparator module 2700 may compare the vendor payment option set and the vendor payment modality set, respectively. In the illustrated embodiment, payment option comparator module 2500 and payment modality comparator module 2700 are shown as separate modules, however, in other embodiments, they may be the same module, or scattered across various devices, or integrated into device 120. In an embodiment, a programmable chip, e.g., a central processing unit, or a portion thereof, may act as both payment modality comparator module 2700 at time A and payment option comparator module 2500 at time B. In an embodiment, payment option comparator module 2500 and payment modality comparator module 2700 may be a part of user device 120.

Referring again to FIG. 1, payment option comparator module 2500 may receive the vendor payment option set 2504 and the user payment option set 2506. In an embodiment, payment option comparator module 2508 may compare all or a portion of vendor payment option set 2504 and the user payment option set 2506. It is noted that the sets may be traversed in any known manner or form for comparison, and it is not required that the entire set of either the vendor payment option set 2504 or the user payment option set 2506 be traversed in their entirety. In an embodiment, payment option comparator module 2508 may receive user preference input 2520 and/or vendor preference input 2522, which may suggest an order in which the payment option or options are to be ranked, categorized, selected, or otherwise preferred, relative to one another or generally. Input from these modules is optional and may vary from system to system.

In an embodiment, payment option comparator module 2508 may determine that there is an overlap between vendor payment option set 2504 and user payment option set 2506. In an embodiment, overlapping set detection module 2510 may generate a calculated overlapping set 2535. It is noted that overlapping set 2535 is not required to be the entire overlapping set 2535. For example, in an embodiment, payment option comparator module 2508 may stop as soon as payment option comparator module 2508 finds one match, and that single match becomes the calculated overlapping set 2535, regardless of whether there are additional overlapping sets.

In an embodiment, payment option comparator module 2508 may determine that there is no overlap between vendor payment option set 2504 and user payment option set 2506. In an embodiment, no overlap in set detection module 2512 may transfer control to no-overlap interfacing module 2530. In an embodiment, if no overlap is detected between the vendor payment option set 2504 and the user payment option set 2506, then the no-overlap interfacing module 2530 may branch to a payment option interfacing module 2550.

For example, for exemplary purposes, in the illustrated example, “Credit Card A” 2122 is found both in the vendor payment option set 2504 and the user payment option set 2506. Thus, in an embodiment, overlapping set detection module 2510 may be invoked, and calculated overlapping set 2535 may include the set of “Credit Card A” 2122. In another embodiment, however, if there is no overlap, then payment option interfacing module 2550 may be invoked.

In an embodiment, payment option interfacing module 2550 may be part of user device 120. In an embodiment, payment option interfacing module 2550 may partially be a part of user device 120, and partially exterior or external to user device 120. In an embodiment, payment option interfacing module 2550 may include payment option supplier contact module 2552. In an embodiment, payment option supplier contact module 2552 may contact one or more payment option administrators to determine if the user's payment option set 2506 can be expanded to include a payment option that is part of the vendor's payment option set 2504. For example, in an embodiment, payment option supplier contact module 2552 may contact the administrator of one or more of the vendor's payment options, to see if the administrator of the payment option (e.g., the credit card company, e.g., Visa) may grant the user access to their payment system, either temporarily, as in a one-use credit card, or permanently, e.g., the granting of a persistent credit line to the user. In an embodiment, payment option supplier contact module 2552 may contact an electronic payment supplier, e.g., PayPal, or Amazon Payments, and request a one-use username and password that the user can use to interact with the vendor system, and then the electronic payment supplier can interface with one of the user payment options to receive reimbursement for processing the transaction with the vendor's payment option.

In an embodiment, payment option interfacing module 2550 may include manufacturer store as intermediary payment option module 2554. For example, in an embodiment, the manufacturer store as intermediary payment option module 2554 may contact an administrator of an online store, e.g., the Apple store, and determine if the Apple store will act as an intermediary to charge the device using its payment systems that are in place, and then handling the payment to the vendor.

In an embodiment, payment option interfacing module 2550 may include related device as intermediary payment option module 2556. For example, in an embodiment, related device as intermediary payment option module 2556 may find a related device that will pay for the item for the user. A related device may be a device that is in the user devices' contact list, or a device that is close to the user, or a device that is on a predetermined list that was approved by the device user, or a device that shares one or more characteristics with the user, or a device for which the same entity is responsible for paying the operating costs. For example, in an embodiment, if the user device 120 that is involved in the transaction is operated by a minor, then the minor's parent's device may be a related device, and may have additional payment options that can be used to interface with the vendor, on behalf of the minor.

In an embodiment, related device as intermediary payment option 2556 may include one or more of a contact list device search module 2558, a proximity device search module 2560, a predetermined device search module 2561, and/or a same-contract device search module 2562. One or more of these modules may be used to find a related device through one or more various methods, or through other methods not detailed here (e.g., through a social network accessed by the user device).

In an embodiment, payment option interfacing module 2550 may include unrelated device as intermediary payment option module 2564, which, in an embodiment, may include contracting device search module 2566 that is configured to search for devices that will take on a contract to assist the user device. For example, a person unrelated to the user may authorize their device to act as a payment intermediary. This intermediary could be nonspecific, could be specific to a store (e.g., only assist for Kohl's), could be specific to a type of stores (e.g., only assist for grocery stores), could be context-dependent (e.g., only assist for a store in which the device owner is currently located), or only authorize their device to act as payment intermediary for certain user payment option types (e.g., only assist for cash transactions). The user of the unrelated device, and the unrelated device, would then bear all or a part of the burden for negotiating reimbursement from the user device, plus whatever fee is allowed or negotiated, either by the unrelated device, by the vendor, by a third party, or by a governmental entity.

In an embodiment, payment option interfacing module 2550 may include selected payment option interface transmitting module 2568, which may be configured to transmit the selected payment option, and/or one or more details about the logistics of the payment option, to the device 120. It is noted that this transmission may be virtual or internal to the device 120, and may not include an actual “transmission,” but merely a handling of data.

In an embodiment, payment option comparator module 2500 may result in a selected payment option 2480, which, in an embodiment, and solely for exemplary purposes, may be credit card A 2122.

In an embodiment, payment modality comparator module 2700 may result in a selected payment modality 2490. Referring again to FIG. 1, in an embodiment, payment modality comparator module 2700 may include modality comparator exemplary module 2702, which may be configured to determine whether there is any overlap between the user payment modality set and the vendor payment modality set. In an example, e.g., the example shown in FIG. 1, exemplary vendor payment modality set 2704 may include credit card swipe+PIN 2324 and credit card swipe+signature 2326.

In an embodiment, payment modality comparator module 2700 may include payment option comparator module 2708. Referring again to FIG. 1, payment modality comparator module 2700 may receive the vendor payment modality set 2704 and the user payment modality set 2706. In an embodiment, payment modality comparator module 2708 may compare all or a portion of vendor payment modality set 2704 and the user payment modality set 2706. It is noted that the sets may be traversed in any known manner or form for comparison, and it is not required that the entire set of either the vendor payment modality set 2704 or the user payment modality set 2706 be traversed in their entirety. In an embodiment, payment modality comparator module 2708 may receive user preference input 2720 and/or vendor preference input 2722, which may suggest an order in which the payment modality or modalities are to be ranked, categorized, selected, or otherwise preferred, relative to one another or generally. Input from these modules is optional and may vary from system to system.

In an embodiment, payment modality comparator module 2708 may determine that there is an overlap between vendor payment modality set 2704 and user payment modality set 2706. In an embodiment, overlapping set detection module 2710 may generate a calculated overlapping set 2735. It is noted that overlapping set 2735 is not required to be the entire overlapping set 2735. For example, in an embodiment, payment modality comparator module 2708 may stop as soon as payment modality comparator module finds one match, and that single match becomes the calculated overlapping set 2735, regardless of whether there are additional overlapping sets.

In an embodiment, payment modality comparator module 2708 may determine that there is no overlap between vendor payment modality set 2704 and user payment modality set 2706. In an embodiment, no overlap in set detection module 2712 may transfer control to no-overlap interfacing module 2730. In an embodiment, if no overlap is detected between the vendor payment modality set 2704 and the user payment modality set 2706, then the no-overlap interfacing module 2730 may branch to a payment modality interfacing module 2640.

In an embodiment, e.g., in an illustrated example as shown in FIG. 1, there may be no overlap between exemplary vendor payment modality set 2704 and exemplary user payment modality set 2706. Thus, in an embodiment, no-overlap interfacing module 2730 may interface with payment modality interfacing module 2640, which may be part of device 120, separate from device 120, or a portion of which may be a part of device 120.

In an embodiment, payment modality interfacing module 2640 may include payment modality user-device as broker module 2650. In an embodiment, payment modality user-device as broker module 2650 facilitates the interface between a user payment modality and a vendor payment modality. For example, payment modality user-device as broker module 2650 may include vendor-accepted modality selecting module 2654 that is configured to select a modality that is acceptable to the vendor and that the device can broker. For example, the vendor may require a credit card swipe and PIN number as a modality. The user may have “audio-voice” as a modality because he or she does not want to physically swipe their card at a station. Thus, the device may act as a broker between the two modalities. Vendor-accepted modality selecting module 2654 may determine that, because it has a microphone to record and convert the PIN, and access to a credit card database, the device can act as a broker between the two modalities.

For example, payment modality user-device as broker module 2650 may include modality adaptation module 2654, which may be configured to take one or more steps in facilitating “conversion” of one modality supported by the device into another. This may be transparent to the user, or may require user assistance. In an embodiment, e.g., the illustrated embodiment, in step 2654EX1, the device may request the user to use the audio-voice modality to speak a PIN number into the microphone of the device, which is recorded. In an embodiment, in step 2654EX2, the device may convert the inputted audio into a PIN number in the format accepted by the vendor. In an embodiment, in step 2654EX3, the credit card data corresponding to a magnetic strip swipe data may be retrieved from a credit card database, e.g., a database run by the credit card company.

In an embodiment, payment modality user-device as broker module 2650 may include converted modality interfacing module 2656, which acts to transmit the converted swipe data and the PIN to the vendor, which treats the transaction as if the user had swiped his or her card and entered his or her PIN data.

In an embodiment, payment modality interfacing module 2640 may include payment modality related-device as broker module 2660. In an embodiment, payment modality related-device as broker module 2660 may include vendor-accepted modality selecting module 2654, which selects one or more of the vendor modalities (for which there is no overlap) that the device is capable of brokering with assistance from another device. In an embodiment, payment modality related-device as broker module 2660 also may include criterion-meeting related device acquiring module 2662, which may use one or more search techniques to find a related device that can assist the user device in completing the transaction. The search for a related device may be similar to that described above.

In an embodiment, criterion-meeting related device acquiring module 2662 may include one or more of contact list device search module 2662A, proximity device search module 2662B, predetermined device search module 2662C, and same-contract device search module 2662D.

In an embodiment, payment modality related-device as broker module 2660 may include related device instructing module 2664, which may be configured to instruct the related device found by module 2662 regarding how to interface the vendor modality with the user device. In an embodiment, this may include transmitting payment information to the related device so that the related device may engage the vendor modality.

In an embodiment, payment modality interfacing module 2640 may include payment modality vendor equipment as broker module 2670. In an embodiment, a vendor may provide equipment, which may be third-party produced, that allows additional modalities. For example, an internet currency provider (e.g., BitCoin) may outfit various Starbucks with devices that allow BitCoin transactions to be processed, using the device as an intermediary, without changing the Starbucks infrastructure. A user device may find these broker devices (which may not be implemented entirely in hardware) and use them to facilitate transactions, and may be invisible to the end user.

In an embodiment, payment modality vendor equipment as broker module 2670 may include vendor equipment communication module 2672. In an embodiment, payment modality vendor equipment as broker module 2670 may include vendor equipment interfacing module 2674. In an embodiment, payment modality vendor equipment as broker module 2670 may include data transmission to vendor equipment module 2676. In an embodiment, payment modality vendor equipment as broker module 2670 may include transaction monitoring module 2678.

In an embodiment, payment modality interfacing module 2640 may include payment modality unrelated device as broker module 2680. For example, a person or entity may authorize their device to act as a payment intermediary for one or more stores (and could be context-dependent, e.g., the store the person is in), where the device uses one or more modalities accepted by the vendor, and the device agrees to act as a broker, in exchange for some sort of reimbursement, from the vendor, or user, or a third party, or positive publicity (e.g., a tweet sent out from a user's twitter account that acknowledges the device owner), similarly to the unrelated device as intermediary payment option module 2564.

In an embodiment, payment modality interfacing module 2640 may include selected payment modality interface transmitting module 2568, which may transmit the selected payment modality, which in an embodiment, the transmission may be internal to the device or within the workings of a particular application or module.

In an embodiment, the selected payment modality 2490 may be paired with the selected payment option into a selected payment option and modality 2750. The combination may not be literal, it may be as simple as setting a flag indicating that a payment option and a payment modality have been selected. In an embodiment, the combination is omitted entirely, and shown in the illustration simply for ease of understanding the illustrated system.

In an embodiment, payment executing module 4000 may be a portion of the user device 120, or separate from the user device 120. Payment executing module 4000 may include vendor contacting module 4010 configured to contact the vendor to apply the payment. In an embodiment, payment executing module 4000 may include intermediary utilization applying module 4020, which may be configured to use any intermediaries, e.g., other devices, e.g., vendor devices, other user devices, other user's devices that are either related or unrelated to the user device, and the like, to assist in the carrying out of the payment.

In an embodiment, payment executing module 4000 may include intermediate steps module 4030, which may be used, for example, to convert one modality to the other, payment transmission module 4040 which may be used to transmit the payment using the selected modality, and confirmation receipt module 4050 which may communicate with the vendor to receive confirmation that the payment has been accepted.

Referring again to FIG. 1, in an embodiment, the payment initiation module 2210 may include a persistent payment button on the device module 2210C. In an embodiment, persistent payment button 2210C may represent a button that allows the user to pay, that does not change based on changing payment channels. It does not necessarily mean that the button is always present, although that may be the case in an embodiment. Persistent payment button 2210C may be a soft key or a hard key and may have a distinctive design or shape, and may be designed to be easy to access, in an embodiment. In an embodiment, persistent payment button 2210C may be a persistent payment soft button 7510. In an embodiment, the persistent payment soft button 7510 may be built into the device firmware. In another embodiment, the persistent payment soft button 7510 may be built into the operating system, or into another component or module of the device. In an embodiment, persistent payment button 2210C may be a physical, e.g., a hard button that is built into the device. For example, persistent payment button 2210C may be implemented as a persistent payment hard button 7512 that is built into the device. In another embodiment, persistent payment hard button 7512 may be programmed to operate as a persistent payment button under particular conditions, e.g., when a particular module is active, or when a particular condition is met. In an embodiment, for example, one or more devices with a persistent payment hard button 7512A may be provided when a user enters a retail store. For example, a wholesale superstore, e.g., a Wal-Mart, may hand out user devices having a persistent payment hard button 7512A to users as they enter the store, in order to facilitate one or more transactions.

In an embodiment, a module 2250 displays a single pay button on the user device. In an embodiment, module 2250 may include condition checking module 7522. Condition checking module 7522 may check one or more conditions to determine, e.g., when a particular module is active, or whether a particular condition is met. In an embodiment, module 2250 may include vendor communication maintaining module 7524. Vendor communication maintaining module 7524 may include a communication module for communicating with the vendor through one or more networks or other media. For example, a user device may communicate with the vendor through a closed vendor network, or through a wireless network provided by the vendor, or through a 4G LTE network provided by an unrelated communication network provider. In an embodiment, module 2250 may include payment channel monitoring module 7526. Module 7526 may monitor one or more payment channels of the user, the user device, or the vendor, and update if one or more of the monitored payment channels changes or becomes active or inactive.

In an embodiment, an input receiving module 7530 may receive input from the persistent payment button 2210C. For example, module 7530 may include button pushing receiving module 7533, which may detect when the persistent payment button 2210C is pressed. In another embodiment, however, persistent payment button 2210C may not be a button, but some other sort of non-button trigger, e.g., a gesture made while operating an augmented reality device, or an infrared signal. In an embodiment, non-button interface receiving module 7532 of input receiving module 7530 may receive the input indicating a potential transaction from the non-button implementation of the persistent payment button.

Then, in an embodiment, using methods previously described, a vendor payment channel acquiring module 2252 acquires an indication that the persistent payment button has been activated, and acquires, e.g., detects, receives, retrieves, or otherwise obtains, the vendor payment channel, e.g., using the vendor payment channel detecting module 2254, partly to detect the vendor payment channels. In an embodiment, vendor payment channel detecting module 2254 may access one or more external resources 2280, as previously described. Specifically, in an embodiment, the selected payment modality and option may be applied to execute the user's request to initiate payment, using the persistent payment button 2210C, and transparently, or partially transparently to the user, with the context of the device (e.g., location, and other factors) determining what specifically the persistent payment button 2210C carries out. In an embodiment, vendor payment channel acquiring module 2252 may include vendor transmission of payment options and/or payment modalities receiving module 7528, which may receive one or more payment options and/or one or more payment modalities from the vendor.

In an embodiment, multi-purpose device 7500 may also include an automated user payment channel selection module 7540, which, in an embodiment, may select a user payment channel for use in carrying out at least a portion of the transaction. In an embodiment, the selection may occur without user intervention. In another embodiment, the selection may include user intervention. Module 7540 may include one or more of payment channel comparator module 7542, weighted payment channel selecting module 7544, and payment channel selecting with non-user external automated input module 7546, which may select a user payment channel automatically, e.g., without further user input after the transaction has been initiated. In an embodiment, e.g., with the use of input module 7546, the process of selecting a user payment channel may be influenced or directly controlled by an external resource, which may or may not be related to the user or the user device.

In an embodiment, multi-purpose device 7500 may include selected automated user payment channel adaptation to one or more vendor payment channel modules 7550. For example, in an embodiment, module 7550 may include external resource for payment channel adapting module 2258, which may be configured to use one or more external resources to complete payment using a context-dependent vendor channel, e.g., through one or more external resources 2280.

In an embodiment, multi-purpose device 7500 may include potential transaction facilitating module 7560, which may include one or more communication modules for communicating with the vendor for which the potential transaction is being negotiated. In an embodiment, potential transaction facilitating module 7540 may include vendor payment systems communication module 7562.

In an embodiment, multi-purpose device 7500 may be implemented with one or more options or modifications. For example, in an embodiment, multi-purpose device 7500 may be implemented as described in payment option hard cap limiter 7520A. In that example, a user has more goods in his or her shopping cart than what he or she has funds to pay with using one or more user payment options of the user payment channel set. Using payment option hard cap limiter 7520A, a user may take items out of his or her shopping cart (which may exist in any known implementation, whether virtual or real), until a signal, e.g., the payment button changes or lights up, or some other appropriate signal, indicating that there are enough funds in the account to pay for the items.

In an embodiment, multi-purpose device 7500 may be implemented as payment option soft cap limiter example 7520B. For example, in an embodiment, a user may add things to his or her shopping car (which may be virtual or physical) until the button goes out, indicating he has overstepped how much funds are in the account, or how many funds have been allocated from the account for this purpose. For example, this could be implemented as a type of budgetary control (e.g., only allowed to spend up to $50 per month at Best Buy), or could be used by parents/spouses/siblings etc. to control spending (e.g., “my thirteen year old son can access my account to pay for things when he is at the comic book store today, but only up to twenty-five dollars).

In an embodiment, multi-purpose device 7500 may be implemented as gift card usage maximizer 7520C. For example, in an embodiment, a user may have an undetermined amount of value remaining on a gift card and the pay button may illuminate or otherwise change shape, form, status, or similar appearance when the items reach a certain value that is close to the total value of the gift card. For example, the payment bar could be realized in multi-colors, e.g., red and green, and the amount of green in the button indicates how much of the gift card would be utilized by the purchases currently in the shopping cart.

In an embodiment, multi-purpose device 7500 may communicate with a retail store front, e.g., retail store front 7570. In an embodiment, a device with a “pay” button, e.g., device 2121, may interface with the retail store front 7570. In an embodiment, a retail store front 7570 may include a receiving one or more devices configured to have a button that interacts and/or responds to the retail vendor module 7572, a distributing the one or more devices to one or more users upon entry to the retail dressage module 7574, a communicating with the one or more devices to change the button status based on one or more conditions module 7578 (e.g., it is noted that, in an embodiment, this module may be assisted by or controlled entirely by an external third party), and a facilitating one or more transactions in response to button pressing module 7579. In an embodiment, the modules listed above may be performed by a third party that is not the user or the vendor, but may or may not be related to one or both.

Referring again to FIG. 1, in an embodiment, payment initiation module 2210 may include simple payment initiation, which may allow for simple payment of one or more items that the user has indicated. For example, a user wants to pay for an item the user has taken a picture of, or placed in a cart, or grabbed, or otherwise indicated (e.g., looked at and pressed a button while wearing augmented reality glasses), and payment happens automatically, or with the touch of one (or a few) buttons, and the details are hidden from the user for both modality and option. The initiation could also be a time-based event, e.g., the start of a movie, or of a round of a fight, or an inning of a baseball game (e.g., for purchase of concessions).

In an embodiment, there may be an augmented reality device 4100. Augmented reality device 4100 may be a device that is owned by the user, and may be associated with the user, e.g., a pair of glasses, or a watch, or it may be a device that is handed out by the vendor, e.g., similarly to how 3D glasses are handed out at movie theaters. Augmented reality device 4100 may include an actual device, and may also include one or more additional devices that support augmented reality device 4100, whether physically located in proximity to the user (e.g., carried by the user in his or her pocket, or worn) or remote to the user.

In an embodiment, augmented reality device 4100 may include duplication module 4110. Duplication module 4110 may be configured to allow a user to pay for an item the user has taken a picture of, or placed in a cart, or grabbed, or otherwise indicated (e.g., looked at and pressed a button while wearing augmented reality glasses), and payment happens automatically, or with the touch of one (or a few) buttons, and the details are hidden from the user for both modality and option.

In an embodiment, augmented reality device 4100 may include a modality negotiation module 4210 may include a user payment modality preference retrieving module 4212 configured to retrieve a user payment modality preference. For example, if a user is sitting down in a crowded coffee shop, a user may be reluctant to get up to pay for a bagel, and risk losing her seat. In an embodiment, modality negotiation module 4210 may include vendor modality retrieving module 4214, which may retrieve a vendor payment modality similarly to one of the previously described techniques. For example, the device may detect, or is told, that a store in which the user is located only supports barcode payment or shopping cart modalities, but the user doesn't want to, or is physically incapable of, wait/waiting in a checkout line or self-checkout station. In an embodiment, modality selecting module 4220 may select a modality to carry out the user's request to pay for the item without additional help or input form the user. For example, modality selecting module 4220 may include modality interfacing database module 4222 and modality interfacing database data retrieving module 4224. For example, in an embodiment, if insufficient data is found in the modality interfacing database 4222, then external resources (Internet, Google, an intranet of data from the device manufacturer) may be used to determine how to interface using a modality accepted by the vendor.

In an embodiment, once a modality is selected, and information about how to interface with that modality is attained, then modality interfacing module may interface using the vendor's preferred modality. For example, modality interfacing module 4230 may include, in an embodiment, for example, vendor modality duplication learning module 4232. For example, in the illustrated barcode modality example, the device may retrieve all or a portion of the store's barcode recognition database. It is noted that this retrieval may not involve the vendor, rather, in an embodiment, the device may retrieve this information from a third party that stores these databases, or from various manufacturers of items that the user has selected.

In an embodiment, vendor modality duplication implementing module 4234 may use the data gathered by vendor modality duplication learning module 4232, and use it to implement the data, e.g., in the example, retrieving the barcode of the item the user wants to purchase, e.g., by using an image processing sensor of the device.

In an embodiment, modality interfacing module 4230 also may include vendor modality duplication interfacing module 4236, which may be configured to interact with the vendor. For example, in the illustrated example, the vendor may have a vendor barcode reading device 6000. Vendor barcode reading device 6000 may include a barcode reader 6002, an input/output (which may be as simple as an LED) 6004, a store back-end 6008, and data processing unit 6006 that processes the data read by the barcode reader 6002. In an embodiment, vendor modality duplication interfacing module 4236 interacts with the data processing unit 6006 of the vendor barcode reading device 6000 to deliver the obtained barcode to the vendor, such that the vendor does not distinguish between the transmission and the usual use of the modality, scanning the barcode at the vendor barcode reading device 6000.

In an embodiment, modality interfacing module 4230 also may include a transaction completing module 4238, which completes the transaction and may inform the user.

In an embodiment, a vendor device and/or system 6100 may interact with the system as previously described. In an embodiment, vendor system 6100 may include a vendor payment channel set communicating module 2610. For example, vendor payment channel set communicating module 2610 may include vendor payment channel set broadcasting module 2612, which may be configured to broadcast information, e.g., using vendor payment option set broadcasting module 2612A and vendor payment modality set broadcasting module 2612B.

In an embodiment, vendor payment channel set communicating module 2610 may include one or more of vendor payment communication negotiation with user device module 2614, which may include vendor payment option communication negotiation with user device module 2614A and vendor payment modality communication negotiation with user device module 2614B, vendor payment channel set determining module 2616, and vendor payment channel set monitoring module 2618. In an embodiment, for example, an example vendor may have exemplary vendor payment modality set 2604EX, and exemplary vendor payment option set 2602EX, which have been previously described herein, and which are selected merely for exemplary purposes and are non-limiting.

In an embodiment, vendor device 6100 may include vendor mass payment with variable payment channels system 6200. For example, in various circumstances, a vendor may want to process payments from many users that use a plurality of modalities, e.g., in a movie theater, people may have items that they've purchased, or a set of people might be waiting in line for a new type of tablet device or video game. Vendor variable payment channels system 6200, in an embodiment, may be designed to facilitate all these people's different payment channels (modalities and options) and process them.

In an embodiment, vendor device 6100 may include vendor operation implementation module 2620, which describes how a vendor may implement a similar system as described with respect to user device 120. For example, in an embodiment, vendor operation implementation module 2620 may include vendor detection of a potential transaction module 2622. Module 2622 may detect that a transaction is about to take place, which may be based on vendor equipment, or based on a change in conditions, e.g., a position of a user. For example, module 2622 may be triggered, for example, by a user walking up to a self-checkout window in a grocery store, and hitting “start” on the screen.

In an embodiment, module 2620 may include a vendor payment channel obtaining module 2624. Vendor payment channel obtaining module 2624 may include vendor payment option obtaining module 2624A and vendor payment modality obtaining module 2624B. Vendor payment option obtaining module 2624A and vendor payment modality obtaining module 2624B may work similarly to their counterpart modules in the user device, e.g., vendor payment channel obtaining module 2410, with the exception that the vendor payment channel set may be stored locally.

In an embodiment of the invention, module 2620 may include a user payment channel obtaining module 2626. User payment channel obtaining module 2626 may include user payment option obtaining module 2626A and user payment modality obtaining module 2626B. Similarly to as above, user payment channel obtaining module 2626 may operate in a similar manner to user payment channel obtaining module 2240, except that because the user payment channel data will probably be remote to vendor device 6100, the techniques for obtaining payment channel data in module 2410 also may be used, as described herein.

In an embodiment of the invention, module 2620 may include a payment channel determining module 2628. Payment channel determining module 2628 may select one or more of a payment option and a payment modality, similarly to that which described with reference to module 2501. Also similarly to module 2501, external resources may be used, for example, as detailed in payment option interfacing module 2550 and payment modality interfacing module 2640.

In an embodiment of the invention, module 2620 may include transaction facilitating module using determined payment channel 2629, which may facilitate the transaction using the selected payment channel and payment modality, similarly to as described in module 4000.

In an embodiment of the invention, an application module 3500 may be implemented by a program or application designer. The application may reside at various levels within the device, e.g., the application may be part of the kernel, part of the firmware, part of the operating system, it may be a preinstalled program or an essential program, or an independent program. The application may be implemented as an API or through any other known means of implementing an application, including hardware, software, firmware, programmable hardware, and others.

In an embodiment, an application module 3500 may include or interface with potential transaction detecting module 3510. In an embodiment, potential transaction detecting module 3510 may perform example 3510A of detecting a transaction or a potential for a transaction. In an embodiment, module 3510 may include one or more of device interface monitoring/communicating module 3512, device information gathering module 3514, device social network monitoring module 3516, device third party data regarding potential transaction receiving module 3518, and application communication with vendor facilitating module 3519.

In an embodiment, an application module 3500 may include or interface with a user payment channel obtaining module 3520. In an embodiment, user payment channel obtaining module 3520 may obtain, e.g., generate, receive, retrieve, or otherwise acquire a user payment channel from one or more sources. In an embodiment, user payment channel obtaining module 3520 may obtain a user payment channel set, and select a user payment channel from that user payment channel set. In an embodiment, user payment channel obtaining module 3520 may include one or more of application obtaining from device module 3522, application obtaining from vendor module 3524, application obtaining from third party module 3526, and application inferring module 3528.

In an embodiment, an application module 3500 may include or interface with a vendor payment channel obtaining module 3530. For example, in an embodiment, user vendor payment channel obtaining module 3530 may include obtaining the vendor payment channel from one or more sources 3530A. In an embodiment, vendor payment channel obtaining module 3530 may obtain a vendor payment channel set, and select one or more of a vendor payment option and/or a vendor payment modality, e.g., a vendor payment channel, from the vendor payment channel set. In an embodiment, vendor payment channel obtaining module 3530 may include one or more of application obtaining from device using device I/O module 3532, application obtaining from vendor directly module 3534, application obtaining from third party module 3536, application inferring module 3538, and application receiving vendor information from developer module 3539.

In an embodiment, an application module 3500 may include or interface with a payment channel set union obtaining module 3540, which, in an embodiment, may determine a usable payment channel set 3540A. In an embodiment, the payment channel set union obtaining module 3540 may include one or more of set comparator module 3542 and comparator output analyzing module 3544. In an embodiment, payment channel set union obtaining module 3540 may include or interface with empty set processing module 3560 or selected payment option and modality obtained from union set 3550 (e.g., which may include weighted union set analyzing module 3552), depending on whether there is union between a user payment channel set and a vendor payment channel set. If there is no union between the user payment channel set and the vendor payment channel set, processing moves to one or more of payment option interfacing module 2550 and/or payment modality interfacing module 2640, which are described in more detail elsewhere.

In an embodiment, vendor mass payment with variable payment channels system 6200 may include a device payment channel determining module 6210 configured to communicate with the device to determine a device's payment channel. In an embodiment, vendor mass payment with variable payment channels system 6200 also may include pay now instruction transmitting module 6212, and device payment acceptance module 6214, used to interface with the device modality as previously described. It is noted that the process by which this is carried out, as previously described with respect to user device 120, may take place at the vendor, at the user device, or partially at each of the devices, or using a third party device. In an embodiment, this process is repeated for all of the devices that are detected by the vendor mass payment with variable payment channels system 6200. It is noted that although system 6200 is called vendor mass payment with variable payment channels system 6200, that is merely for illustrative purposes, and in an embodiment, system 6200 may be provided by a third party, e.g., a device manufacturer, that may put limits on what kinds of devices are eligible for the mass payment system (e.g., only Samsung-branded phones are eligible, or only phones communicating on a 4G LTE network are eligible).

In an embodiment of the invention, a device, e.g., device 6500, may be used as a device intermediary, as previously described, with respect to module 2670. For example, a person or entity may authorize their device to act as a payment intermediary for one or more stores (and could be context-dependent, e.g., the store the person is in), where the device uses one or more modalities accepted by the vendor, and the device agrees to act as a broker, in exchange for some sort of reimbursement, from the vendor, or user, or a third party, or positive publicity (e.g., a tweet sent out from a user's twitter account that acknowledges the device owner). In an embodiment, device 6500 may include a condition defined as acceptable for a device to act as an intermediary detecting module 6510. Module 6510 may perform calculations or receive instructions, e.g., from a user, or from a third party with limited agency over the device, that determine when device 6500 is allowed to act as an intermediary. For example, module 6510 may include determining one or more conditions that permit the device to act as an intermediary device for unrelated devices module 6512, which may determine a condition under which device 6500 will act as an intermediary. In an embodiment, module 6510 also may include a detecting one or more of the determined conditions that permit the device to act as an intermediary device for unrelated devices module 6514, which may detect, or be informed of, one or more acceptable conditions. An example of one or more conditions may be that a device is set to act as an intermediary to unrelated devices when the device is located at an upscale shopping mall. Another example may be that a device is set to act as an intermediary to unrelated devices when the device is located at a store that is part of a particular corporate chain. Another example may be that a device is set to act as an intermediary to unrelated devices when the device is located at a store that accepts a particular type of payments (e.g., Google Wallet).

In an embodiment of the invention, device 6500 may include availability as an intermediary informing module 6520, which communicates availability as an intermediary device to a variety of devices through one or more methods. In an embodiment, module 6520 may include one or more of signal broadcasting module 6522 for broadcasting a signal indicating availability as an intermediary that can be picked up by the client device, vendor communication and/or registration module 6524 for contacting the vendor and registering the device as available to perform intermediary work, listening for devices module 6526 for listening to communication involving one or more client devices and/or offering/soliciting as an intermediary, and third party requestor communication module for receiving communication from a non-vendor third party (e.g., a service provider to the vendor or to the client) requesting assistance as an intermediary 6528.

In an embodiment of the invention, device 6500 may include Intermediary acceptance module 6530 which may accept to act as an intermediary for the client device. This module may include intermediary compensation and/or agreement terms negotiating module 6532 and/or client data collecting module 6534. In an embodiment of the invention, device 6500 may include intermediary performance module 6540 for performing intermediary assistance in payment option and/or payment modality between client (user) and vendor.

Referring again to FIG. 1, a manufacturer marketplace may act as an intermediary, as described in step 2554. Such an intermediary may include developer marketplace 6600. For example, a store operated by the operating system manufacturer of the device (e.g., the Microsoft Xbox games store for a device running a Microsoft operating system, e.g., Windows Phone 8.0, receives a request to assist with a transaction, e.g., purchasing a coffee at a coffee shop). The marketplace may collect data regarding payment channels of the coffee shop and the client device that is attempting to purchase the coffee. The marketplace then may provide the payment to the vendor for a transaction, using a payment channel that the client device does not have access to, and then may use its own existing payment channel with the client device to recapture the cost of the transaction.

In an embodiment, marketplace 6600 may include request for payment channel assistance receiving module 6610. For example, an online shopping marketplace (e.g., a transaction facilitator, e.g., the Apple App Store, or Google Play Store) receives a request for assistance with one or more payment channels and/or payment modalities from the client device. In an embodiment, marketplace 6600 may include payment channel data gathering module 6620, which may be configured to gather information about the payment channels used by the client and the vendor, either directly from one or more of the client and/or vendor, or from other devices in the area.

In an embodiment, marketplace 6600 may include a payment channel vendor payment facilitating module 6630 configured to assist in providing payment to the vendor, utilizing one or more tools at its disposal, including possibly third party devices not under the direct control of the vendor, portions of the client device, the vendor device, or other resources.

In an embodiment, marketplace 6600 may include a payment channel client reimbursement facilitating module 6640 configured to, if necessary, if the vendor used one or more payment channels not directly involving the client device, the marketplace uses its payment channels, e.g., which may be preexisting due to the client relationship with the marketplace to collect the cost of the transaction from the client device. In another embodiment, marketplace 6600 may include marketplace as identifier tool module 6635 configured to may work with the vendor to confirm or certify an identity of the client device, in order to facilitate the transaction (e.g., which may be credit or accounts-payable based), rather than actually carry out the transaction.

Referring again to FIG. 1, e.g., FIG. 1C, other alternatives may be incorporated into the system. Some exemplary examples of these alternatives may include a frequent shopper reward application module 2160 that ensures that a user's frequent shopper cards are available as an option, or are automatically applied, a device search engine interface 2350, which goes to a search engine to get instructions to figure out how to interface with a particular payment channel, e.g., option or modality. In an embodiment, the system may include a credit card rewards program maximize module 2130 that may be configured to determine which credit card of a set of credit cards of the user to apply as the payment option to maximize user rewards, which may be based on an efficiency algorithm or a user preference that has been entered into the device.

In an embodiment, the system may include a trusted device voucher module 2354A, which, in an embodiment, in trying to verify the identity of a user, the vendor asks a device it trusts, e.g., a device it authenticates through a different means, to verify that the user device is legitimate. For example, a user's brother might not want to authenticate, or be unable to authenticate, so the user authenticates to the store with the user's device. The store then asks the user to verify that the person is indeed the user's brother. It could be limited to preexisting relationships, or types of relationships, e.g., blood relationships, marriage relationships, and familial relationships, or could use contact list information, or social network information.

In an embodiment, the system may include friendly device search interface 2360 configured to search the area to determine whether there are any devices that share a characteristic with the user device that are in the vicinity.

In an embodiment, the system may include a small business assistance module 2140 configured to figure out whether a user wants to use a corporate card or not, e.g., based on one or more of where the user is located, what store the user is located in, what the user is buying, who the user is with, and the like.

In an embodiment, the system may include a frequent shopper card guaranteed use module 2150 configured to ensure that a user's frequent shopper card number is engaged when the purchase is completed, so that the user gets the credit.

Referring now to FIG. 2, FIG. 2 illustrates an example environment 200 in which the methods, systems, circuitry, articles of manufacture, and computer program products and architecture, in accordance with various embodiments, may be implemented by one or more user devices 220. As shown in FIG. 2A, one or more user devices 220, intermediate devices 230, external devices 240, and vendor devices 280 may communicate via one or more communication networks 240. In an embodiment, intermediate device(s) 230 may include intermediate device “A” 232 and/or intermediate device “B” 234. In an embodiment, vendor device 280 may include a vendor transaction processing system 282, a vendor interface system 284, and may include a vendor payment channel set 204, which may include one or more of a vendor payment modality set 204A and a vendor payment option set 204B. These will be discussed in more detail herein with respect to specific examples.

In an embodiment, external device 240 may include one or more of device list 242, vendor list 244, device communication interface 246, and vendor communication interface 248. Device 240 is listed as “external” not because it is necessarily external in temporal location or function, because in an embodiment, it may not be, but because external device 240 is not under the control of vendor device 280, user device 220, or intermediate device(s) 230, although any or all of the foregoing may communicate with external device 240.

User device 220 may be any electronic device, portable or not, that may be operated by or associated with one or more users. User device 220 is shown as interacting with a user 105. As set forth above, user 105 may be a person, or a group of people, or another entity that mimics the operations of a user. In an embodiment, user 105 may be a computer or a computer-controlled device. User device 220 may be, but is not limited to, a cellular phone, a network phone, a smartphone, a tablet, a music player, a walkie-talkie, a radio, a USB drive, a portable solid state drive, a portable disc-type hard drive, an augmented reality device (e.g., augmented reality glasses and/or headphones), wearable electronics, e.g., watches, belts, earphones, or “smart” clothing, earphones, headphones, audio/visual equipment, media player, television, projection screen, flat screen, monitor, clock, appliance (e.g., microwave, convection oven, stove, refrigerator, freezer), a navigation system (e.g., a Global Positioning System (“GPS”) system), a medical alert device, a remote control, a peripheral, an electronic safe, an electronic lock, an electronic security system, a video camera, a personal video recorder, a personal audio recorder, and the like.

In an embodiment, user device 220 may be associated with user 105, and vendor device 280 may be associated with vendor 106. In an embodiment, user 105 may want to acquire goods and/or services from vendor 106, in what will be referred to throughout this application as a “transaction.” It is noted that “transaction” does not necessarily limit to the payment for a good or service. The transaction may incorporate such things as the user selecting an item, or requesting more information about an item from the vendor.

In an embodiment, user 105 and user device 220 may facilitate the transaction using a user payment channel 202. A user payment channel 202 may include one or more of a user payment modality 202A and a user payment option 202B. A user payment modality 202 may be a method by which the user 105 compensates the vendor 106 for the one or more goods and services. A user payment option 202B may be a specific type or form of payment by which the user 105 attempts to compensate the vendor 106 for the goods or services. Examples of user payment options 202B and user payment modalities 202A are found in FIG. 1.

In an embodiment, vendor 106 and vendor device 280 may facilitate the transaction using a vendor payment channel 204. A vendor payment channel may include one or more of a vendor payment modality 204A and a vendor payment option 204B. A vendor payment modality 204A may be a method by which the user 105 compensates the vendor 106 for the one or more goods and services. A vendor payment option 204B may be a specific type or form of payment by which the user 105 attempts to compensate the vendor 106 for the goods or services. Examples of vendor payment options 204B and vendor payment modalities 204A are found in FIG. 1.

In an embodiment, the user 105 may wish to use the user payment channel 202 to complete the transaction, regardless of a status of the vendor payment channel 204. In an embodiment, the user 105 may desire to not know what the vendor payment channel is, only that the transaction can be completed without the user changing his user payment channel 202 to match the vendor payment channel 204. In an embodiment, there may be no overlap, or an incomplete overlap, between the user payment channel 202 and the vendor payment channel 204. In such instances, the device may select a user payment channel 202, and then perform one or more operations to interface with the vendor payment channel 204. Specific examples of these types of operations will be described in more detail herein with respect to the figures. In an embodiment, the user device 220 may use one or more intermediate devices 230 in order to complete the transaction, or may use one or more external devices 240 that have resources that allow a vendor payment channel to be used by the device, even if the device does not necessarily support the vendor payment channel 204 directly. In an embodiment, the user may remain unaware that the user payment channel 202 is not being used for the entire transaction, e.g., the use of other resources and/or devices to complete the transaction may be hidden from the user 105. In an embodiment, the device interface may be simplified so that the user 105 only presses a single button to carry out a transaction, and selection of a user payment channel 202 and execution of the transaction using a vendor payment channel 204 happens seamlessly, and without further input from the user 105.

Referring now to FIG. 2B, device 280 may include an operating system 224 with a kernel 223. In this context, operating system 224 refers to any hardware, software, firmware, and combination thereof which is considered at the core or baseline of a device. For example, applications that interact directly with hardware may be considered to be part of an operating system. In an embodiment, operating system 224 may be an FPGA, printed circuit board, or other wired device. In an embodiment, operating system 224 may include one or more of Google's Android, Apple's iOS, Microsoft's Windows, various implementations of Linux, and the like. In an embodiment, operating system 224 may include a root menu for one or more televisions, stereo systems, media players, and the like. In an embodiment, operating system 224 may be a “home” or base screen of a device.

Referring again to FIG. 2B, in an embodiment, device 280 may include a vendor interface system 284. Vendor interface system 284 may include any hardware, software, firmware, and combination thereof that allow interaction device 280. In an embodiment, vendor interface system 284 may include a monitor, screen, touchscreen, liquid crystal display (“LCD”) screen, light emitting diode (“LED”) screen, speaker, handset, earpiece, keyboard, keypad, touchpad, mouse, trackball, remote control, button set, microphone, video camera, still camera, a charge-coupled device (“CCD”) element, a photovoltaic element, and the like.

Referring again to FIG. 2B, in an embodiment, device 280 may include a device memory 226. In an embodiment, device memory 226 may include memory, random access memory (“RAM”), read only memory (“ROM”), flash memory, hard drives, disk-based media, disc-based media, magnetic storage, optical storage, volatile memory, nonvolatile memory, and any combination thereof. In an embodiment, device memory 226 may be separated from the device, e.g., available on a different device on a network, or over the air. For example, in a networked system, there may be many devices 280 whose device memory 226 is located at a central server that may be a few feet away or located across an ocean. In an embodiment, device 280 may include a device memory 226. In an embodiment, memory 226 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In an embodiment, memory 226 may be located at a single network site. In an embodiment, memory 226 may be located at multiple network sites, including sites that are distant from each other.

Referring again to FIG. 2B, device memory 226 may include, for example, payment data conversion tables 226A, which may be used in implementations as discussed in more detail herein.

Referring again to FIG. 2B, in an embodiment, device 280 may include vendor transaction processing system 282. In an embodiment, vendor transaction processing system 282 may include components for processing transactions, including any component that allows the device to interact with its environment. For example, in an embodiment, vendor transaction processing system 282 may include one or more sensors, e.g., a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), a radio, including a wireless radio, a transmitter, a receiver, an emitter, a broadcaster, and the like.

Referring again to FIG. 2B, device 280 may include a detecting system 283 for detecting various conditions, in some embodiments, doing so in accordance with the vendor transaction processing system 282 including one or more of the sensors described above. Detecting system 283 may include a condition detecting system 283A which may include functionality for detecting particular conditions, as described in the specific embodiments further herein. In an embodiment, detecting system 283 may include a client device detecting system 283B for detecting the set of two or more client devices. In various embodiments, detecting system 283 may receive data, rather than collecting data, or may carry out a combination of receiving, collecting, generating, and/or processing data. Detecting system 283 may interact with processor 222 and processing module 250.

Referring again to FIG. 2B, device 280 may include an external resource managing system 285 that manages external resources, as described in more detail further herein. Managing external resources may include an external resource contacting module 285A which may contact external resources, find external resources, and/or maintain contact with external resources, as described in more detail herein. In an event that an external resource is used to facilitate a transaction, external resource negotiating module 285B may be used to negotiate with one or more external resources, in conjunction with one or more modules of processor 222.

Referring again to FIG. 2B, FIG. 2B shows a more detailed description of device 280. In an embodiment, device 280 may include a processor 222. Processor 222 may include one or more microprocessors, Central Processing Units (“CPU”), a Graphics Processing Units (“GPU”), Physics Processing Units, Digital Signal Processors, Network Processors, Floating Point Processors, and the like. In an embodiment, processor 222 may be a server. In an embodiment, processor 222 may be a distributed-core processor. Although processor 222 is as a single processor that is part of a single device 280, processor 222 may be multiple processors distributed over one or many devices 280, which may or may not be configured to operate together. Referring again to FIG. 2B, processor 222 is illustrated as being configured to execute computer readable instructions in order to execute one or more operations described above, and as illustrated in FIGS. 7, 8A-8D, 9A-9C, 10A-10C, and 11A-11H. In an embodiment, processor 222 is designed to be configured to operate as processing module 250, which may include one or more of request for potential transaction initiation including indicator of intent to carry out potential transaction receiving module 252, transaction data including request to utilize a particular payment channel for carrying out at least a portion of the potential transaction acquiring module 254, acquired particular payment channel absence from a set of one or more directly accepted payment channels determining module 256, facilitation of at least a portion of the potential transaction configured to provide an appearance of using the acquired payment channel to at least one party to the potential transaction negotiating module 258.

Referring now to FIG. 3, FIG. 3 illustrates an exemplary implementation of the request for potential transaction initiation including indicator of intent to carry out potential transaction receiving module 252. As illustrated in FIG. 3, the request for potential transaction initiation including indicator of intent to carry out potential transaction receiving module may include one or more sub-logic modules in various alternative implementations and embodiments. For example, as shown in FIG. 3, e.g., FIG. 3A, in an embodiment, module 252 may include request for potential transaction initiation including indicator of intent to carry out potential transaction with a registered user of a device receiving from the device module 302. In an embodiment, module 302 may include request for potential transaction initiation including indicator of intent to carry out potential transaction with a registered user of a device receiving from the device that is configured to be carried by the user module 304. In an embodiment, module 304 may include request for potential transaction initiation including indicator of intent to carry out an exchange of currency and/or equivalents for goods and/or services with a registered user of a device receiving from the device that is configured to be carried by the user module 306. In an embodiment, module 306 may include request for potential transaction initiation including indicator of intent to carry out an exchange of currency and/or equivalents for goods and/or services using one or more of a particular payment modality and a particular payment option with a registered user of a device receiving from the device that is configured to be carried by the user module 308. In an embodiment, module 308 may include request for potential transaction initiation including indicator of intent to carry out an exchange of currency and/or equivalents for goods and/or services using near-field communication with a registered user of a device receiving from the device that is configured to be carried by the user module 310.

Referring again to FIG. 3, e.g., FIG. 3B, in an embodiment, module 252 may include one or more of request for potential transaction initiation including indicator of intent to submit payment for one or more goods and/or services receiving module 312 and request for potential transaction initiation including indicator of intent to carry out potential transaction receiving from a vendor-associated device module 320. In an embodiment, module 312 may include request for potential transaction initiation including indicator of intent to submit payment for one or more goods and/or services using one or more of a particular payment option and a particular payment modality receiving module 314. In an embodiment, module 314 may include one or more of request for potential transaction initiation including indicator of intent to submit payment for one or more goods and/or services using a particular payment option receiving module 316 and request for potential transaction initiation including indicator of intent to submit payment for one or more goods and/or services using a particular payment modality receiving module 318. In an embodiment, module 320 may include one or more of request for potential transaction initiation including indicator of intent to carry out potential transaction receiving from a vendor-associated device provided by a payment channel provider device module 322, request for potential transaction initiation including indicator of intent to carry out potential transaction receiving responsive to a user interaction detected by the vendor-associated device module 324, and request for potential transaction initiation including indicator of intent to carry out potential transaction receiving from an input/output component of the vendor-associated device module 328. In an embodiment, module 324 may include one or more of request for potential transaction initiation including indicator of intent to carry out potential transaction receiving responsive to a user entering a debit card personal identification number into vendor-associated device module 326.

Referring again to FIG. 3, e.g., FIG. 3C, in an embodiment, module 252 may include request for potential transaction initiation generated in response to particular condition detection, including indicator of intent to carry out potential transaction receiving module 330. In an embodiment, module 330 may include request for potential transaction initiation generated in response to user-based particular condition detection, including indicator of intent to carry out potential transaction receiving module 332. In an embodiment, module 332 may include one or more of request for potential transaction initiation generated in response to user-based action detection, including indicator of intent to carry out potential transaction receiving module 334 and request for potential transaction initiation generated in response to user-based location detection, including indicator of intent to carry out potential transaction receiving module 338. In an embodiment, module 334 may include request for potential transaction initiation generated in response to user-based movement of a particular item detection, including indicator of intent to carry out potential transaction, receiving module 336.

Referring again to FIG. 3, e.g., FIG. 3D, in an embodiment, module 252 may include one or more of request for potential transaction initiation including indicator of intent to carry out potential transaction receiving from a device that stores data regarding a user receiving module 340 and request for potential transaction initiation data including indicator data describing intent to carry out potential transaction receiving module 342.

Referring now to FIG. 4, FIG. 4 illustrates an exemplary implementation of transaction data including request to utilize a particular payment channel for carrying out at least a portion of the potential transaction acquiring module 254. As illustrated in FIG. 4, the transaction data including request to utilize a particular payment channel for carrying out at least a portion of the potential transaction acquiring module 254 may include one or more sub-logic modules in various alternative implementations and embodiments. For example, as shown in FIG. 4, e.g., FIG. 4A, in an embodiment, module 254 may include one or more of transaction data including request to utilize a particular payment channel for carrying out at least a portion of the potential transaction receiving module 402 and transaction data including request to utilize a particular payment channel for carrying out at least a portion of the potential transaction generating module 412. In an embodiment, module 402 may include one or more of transaction data including request to utilize a particular payment modality for carrying out at least a portion of the potential transaction receiving module 404 and transaction data including request to utilize a particular payment channel for carrying out at least a portion of the potential transaction receiving from a transaction logging device module 410. In an embodiment, module 404 may include transaction data including request to utilize a particular payment modality of near-field communication equipped device proximity contact sensor for carrying out at least a portion of the potential transaction receiving module 406. In an embodiment, module 406 may include transaction data including request to utilize a particular payment modality of near-field communication equipped device proximity contact sensor for submitting payment for an ordered coffee drink receiving from a device module 408. In an embodiment, module 412 may include transaction data including request to utilize a particular payment channel for carrying out at least a portion of the potential transaction generating at least partially through inference based on received data module 414.

Referring again to FIG. 4, e.g., FIG. 4B, in an embodiment, module 254 may include one or more of particular data that is generated by a device associated with a user receiving module 416 and transaction data including the request to utilize a particular payment channel for carrying out at least a portion of the potential transaction generating at least partly based on the received particular data module 418. In an embodiment, module 416 may include one or more of particular data including a list of one or more device-supported payment options that is generated by the device associated with the user receiving module 420 and particular data about one or more properties of the device that is generated by the device associated with the user receiving module 424. In an embodiment, module 420 may include particular data including a list of one or more device-supported credit card payment options that is generated by the device associated with the user receiving module 422. In an embodiment, module 424 may include one or more of particular data about one or more supported data transmission protocols of the device that is generated by the device associated with the user receiving module 426, particular data about one or more payment channel data accessible by the device that is generated by the device associated with the user receiving module 428, and particular data about one or device settings read by the device associated with the user receiving module 430.

Referring again to FIG. 4, e.g., FIG. 4C, in an embodiment, module 254 may include one or more of transaction data that is part of the request for potential transaction initiation, said transaction data including request to utilize a particular payment channel for carrying out at least a portion of the potential transaction acquiring module 432, transaction data including request to utilize a particular payment channel for carrying out at least a portion of the potential transaction detecting module 434, and transaction data including request to utilize one or more of a particular payment option and a particular payment modality for carrying out at least a portion of the potential transaction detecting module 436.

Referring now to FIG. 5, FIG. 5 illustrates an exemplary implementation of acquired particular payment channel absence from a set of one or more directly accepted payment channels determining module 256. As illustrated in FIG. 5, the acquired particular payment channel absence from a set of one or more directly accepted payment channels determining module 256 may include one or more sub-logic modules in various alternative implementations and embodiments. For example, as shown in FIG. 5, e.g., FIG. 5A, in an embodiment, module 256 may include one or more of acquired particular payment channel including a particular payment modality absence from a set of one or more directly accepted payment channels determining module 502, acquired particular payment channel including a particular payment option absence from a set of one or more directly accepted payment channels determining module 506, acquired particular payment channel including a particular payment option and a particular payment modality absence from a set of one or more directly accepted payment channels determining module 510, and acquired particular payment channel absence from a set of one or more payment channels not accepted when a particular condition is present determining module 512. In an embodiment, module 502 may include acquired particular payment channel including a particular payment modality of using a credit card with electronic signature recognition absence from a set of directly accepted payment channels determining module 504. In an embodiment, module 506 may include acquired particular payment channel including a particular payment option of a credit card from a particular company absence from a set of directly accepted payment channels determining module 508. In an embodiment, module 512 may include acquired particular payment channel absence from a set of one or more payment channels not accepted when an unencrypted channel is used determining module 514.

Referring again to FIG. 5, e.g., FIG. 5B, in an embodiment, module 256 may include one or more of acquired particular payment channel absence from a set of one or more accepted as originally transmitted from a source payment channels determining module 516, acquired particular payment channel absence from a set of one or more accepted in a source-requested format payment channels determining module 518, acquired particular payment channel transmitting to an external resource module 520, determination regarding absence of the acquired particular payment channel from the set of one or more directly accepted payment channels receiving module 522, set of one or more directly accepted payment channels receiving module 526, and acquired particular payment channel to at least one of the payment channels present in the received set of one or more directly accepted payment channels comparing module 528. In an embodiment, module 520 may include acquired particular payment channel transmitting to an external resource selected at least partly based on one or more properties of the acquired particular payment channel module 524.

Referring again to FIG. 5, e.g., FIG. 5C, in an embodiment, module 256 may include one or more of acquired particular payment channel absence from a set of one or more directly accepted payment channels determining by polling one or more devices module 530 and acquired particular payment channel absence from a set of one or more directly accepted payment channels determining by processing data regarding one or more device components of a vendor device module 532.

Referring now to FIG. 6, FIG. 6 illustrates an exemplary implementation of facilitation of at least a portion of the potential transaction configured to provide an appearance of using the acquired payment channel to at least one party to the potential transaction negotiating module 258. As illustrated in FIG. 6, the facilitation of at least a portion of the potential transaction configured to provide an appearance of using the acquired payment channel to at least one party to the potential transaction negotiating module 258 may include one or more sub-logic modules in various alternative implementations and embodiments. For example, as shown in FIG. 6A, in an embodiment, module 258 may include one or more of one or more resources designed to allow execution of at least a portion with an appearance of using the acquired particular payment channel to at least one party acquiring module 602, instruction to a user device to obtain transaction data at least partly using the acquired particular payment channel transmitting module 604, instruction to a user device to manipulate obtained transaction data into a format configured to be used with a further payment channel other than the particular payment channel transmitting module 606, and potential transaction facilitating at least partly using the further payment channel module 608. In an embodiment, module 604 may include instruction to a user device to obtain transaction data at least partly using the acquired particular payment channel, so that an appearance of using the acquired particular payment channel to at least one party to the potential transaction is generated transmitting module 610. In an embodiment, module 606 may include one or more resources configured to assist in manipulating obtained transaction data into a format configured to be used with a further payment channel other than the particular payment channel providing to the user device module 612. In an embodiment, module 612 may include database of vendor product codes configured to assist in manipulating obtained transaction data into a format configured to be used with a further payment channel other than the particular payment channel providing to the user device module 614. In an embodiment, module 608 may include potential transaction facilitating at least partly using the further payment channel without providing notification to a user of the use of the further payment channel module 616.

Referring again to FIG. 6, e.g., FIG. 6B, in an embodiment, module 258 may include one or more of one or more resources configured to facilitate at least a portion of the potential transaction determining module 618 and data regarding the one or more determined resources transmitting to a user device configured to use the particular payment channel module 620. In an embodiment, module 618 may include one or more resources configured to facilitate a first portion of the potential transaction using the particular payment channel and to facilitate a second portion of the potential transaction using a further payment channel that is present in the set of one or more directly accepted payment channels determining module 622. In an embodiment, module 622 may include one or more devices configured to directly accept both the acquired particular payment channel and the further payment channel that is present in the set of one or more directly accepted payment channels determining module 624. In an embodiment, module 624 may include one or more of list of one or more devices configured to directly accept both the acquired particular payment channel and the further payment channel that is present in the set of one or more directly accepted payment channels generating module 626, particular device from the list of one or more devices selecting module 628, and one or more devices within a particular proximity to a relevant entity configured to directly accept both the acquired particular payment channel and the further payment channel that is present in the set of one or more directly accepted payment channels determining module 630.

Referring again to FIG. 6, e.g., FIG. 6C, in an embodiment, module 258 may include module 618, module 622, and module 624, as previously described. In an embodiment, module 624 may include one or more devices having a particular property polling to determine at least one device configured to directly accept both the acquired particular payment channel and the further payment channel that is present in the set of one or more directly accepted payment channels module 632. In an embodiment, module 632 may include one or more of one or more devices having a particular location property polling to determine at least one device configured to directly accept both the acquired particular payment channel and the further payment channel that is present in the set of one or more directly accepted payment channels module 634 and one or more devices connected to a particular communication network polling to determine at least one device configured to directly accept both the acquired particular payment channel and the further payment channel that is present in the set of one or more directly accepted payment channels module 636.

Referring again to FIG. 6, e.g., FIG. 6D, in an embodiment, module 258 may include module 618, module 622, module 624, and module 632, as previously described. In an embodiment, module 632 may include one or more devices manufactured by a particular manufacturer polling to determine at least one device configured to directly accept both the acquired particular payment channel and the further payment channel that is present in the set of one or more directly accepted payment channels module 638.

Referring again to FIG. 6, e.g., FIG. 6E, in an embodiment, module 258 may include one or more of a resource configured to facilitate at least a portion of the potential transaction configured to provide an appearance of using the acquired particular payment channel to at least one party to the potential transaction locating module 640 and located resource configured to facilitate at least the portion of the potential transaction assistance requesting module 642. In an embodiment, module 640 may include a resource configured to facilitate at least a portion of the potential transaction configured to provide an appearance of using the acquired particular payment channel to at least one party to the potential transaction locating at least partly based on a property of the acquired particular payment channel module 644. In an embodiment, module 642 may include request for located resource to contact a party to the transaction transmitting module 646.

Referring again to FIG. 6, e.g., FIG. 6F, in an embodiment, module 258 may include one or more of intermediary device having a particular property and configured to facilitate at least a portion of the potential transaction selecting module 648, agreement with the intermediary device to facilitate at least a portion of the potential transaction managing device 650, and data regarding the intermediary device transmitting to a user device associated with the at least one party to the potential transaction transmitting module 652. In an embodiment, module 648 may include one or more of intermediary device configured to interface with the acquired particular payment channel and configured to facilitate at least a portion of the potential transaction selecting module 654, intermediary device configured to interface with the acquired particular payment channel and to interface with a further payment channel present in the set of one or more directly accepted payment channels determining module selecting module 656, and intermediary device having a preexisting vendor agreement and configured to facilitate at least a portion of the potential transaction selecting module 658.

Referring again to FIG. 6, e.g., FIG. 6G, in an embodiment, module 258 may include one or more of module 648, module 650, and module 652, as previously described. In an embodiment, module 648 may include one or more of intermediary device having at least one component provided by a particular provider and configured to facilitate at least a portion of the potential transaction selecting module 660 and intermediary device having a particular application stored in memory and configured to facilitate at least a portion of the potential transaction selecting module 662. In an embodiment, module 650, may include compensation level for intermediary device to facilitate at least a portion of the potential transaction managing device setting module 664. In an embodiment, module 664 may include percentage of sale as compensation for intermediary device to facilitate at least a portion of the potential transaction managing device setting module 666.

Referring again to FIG. 6, e.g., FIG. 6H, in an embodiment, module 258 may include one or more of module 648, module 650, and module 652, as previously described. In an embodiment, module 650 may include preexisting agreement for intermediary device to facilitate at least a portion of the potential transaction managing device verifying module 668. In an embodiment, module 668 may include preexisting agreement between a nonparty to the potential transaction and the intermediary device to facilitate at least a portion of the potential transaction managing device verifying module 670. In an embodiment, module 652 may include one or more of address of the intermediary device transmitting to the user device associated with the at least one party to the potential transaction transmitting module 672 and identity verification code used by intermediary device transmitting to the user device associated with the at least one party to the potential transaction transmitting module 674.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 7 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIGS. 8-11 as well as the other operations to be described herein may be performed by at least one of a machine, an article of manufacture, or a composition of matter.

Referring now to FIG. 7, FIG. 7 shows operation 700, e.g., an example operation of a device 220 operating in an environment 200. In an embodiment, operation 700 may include operation 702 depicting receiving a potential transaction initiation request, said potential transaction initiation request configured to indicate an intent to carry out a potential transaction. For example, FIG. 2, e.g., FIG. 2B, shows request for potential transaction initiation including indicator of intent to carry out potential transaction receiving module 252 receiving a potential transaction initiation request (e.g., the request may be in the form of a signal, e.g., from a component, either external or internal to a device, through any known format, the request may be in the form of data, retrieved from a memory of any kind and at any physical location or arrangement, or in the form of a detectable event, e.g., a user making a particular motion, speaking a particular word, using a particular augmented reality device, and the like), said potential transaction initiation request configured to indicate an intent (e.g., the intent may be explicit or inferable, and in the case of data or a signal, the intent belongs to the underlying party represented by the data, and is imputed to the data or signal, which cannot by itself have a feature such as “intent”) to carry out a potential transaction (e.g., an exchange of a form of compensation for goods and/or services, whether it actually occurs or not, at any stage, including preparation, selection of an item, verification of a price, verification of an identity, and equivalents).

Referring again to FIG. 7, operation 700 may include operation 704 depicting acquiring potential transaction data that includes a request to use a particular payment channel for at least a portion of the potential transaction. For example, FIG. 2, e.g., FIG. 2B, shows transaction data including request to utilize a particular payment channel for carrying out at least a portion of the potential transaction acquiring module 254 acquiring (e.g., obtaining, receiving, calculating, selecting from a list or other data structure, receiving, retrieving, or receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) potential transaction data (e.g., any data related to an exchange of a form of compensation for goods and/or services, whether it actually occurs or not, at any stage, including preparation, selection of an item, verification of a price, verification of an identity, and equivalents) that includes a request to use a particular payment channel (e.g., at least one payment option (e.g., a form of a medium of exchange, e.g., money, currency, credit, and equivalents) and/or at least one payment modality (e.g., a method of performing the exchange, a medium by which the exchange takes place, a facilitator of exchange of compensation, and equivalents, that are available)) for at least a portion of the potential transaction (e.g., an exchange of a form of compensation for goods and/or services, whether it actually occurs or not, at any stage, including preparation, selection of an item, verification of a price, verification of an identity, and equivalents).

Referring again to FIG. 7, operation 700 may include operation 706 depicting determining that the acquired particular payment channel includes a payment channel that is not directly accepted. For example, FIG. 2, e.g., FIG. 2B, shows acquired particular payment channel absence from a set of one or more directly accepted payment channels determining module 256 determining (e.g., carrying out one or more logical steps, through any known process by machine, which may be assisted by human intellect in part), that the acquired particular payment channel (e.g., at least one payment option (e.g., a form of a medium of exchange, e.g., money, currency, credit, and equivalents) and/or at least one payment modality (e.g., a method of performing the exchange, a medium by which the exchange takes place, a facilitator of exchange of compensation, and equivalents, that are available) includes a payment channel that is not directly accepted (e.g., is not advertised as being accepted, is not listed as being accepted, is not capable of being accepted, is not capable of being accepted without a particular additional resource, is not capable of being accepted without performing one or more steps deemed as “extra” steps, and the like, e.g., it is possible that “not directly accepted” may be directly accepted if enough steps, e.g., conversions or manipulations, were carried out, but that have been determined, either previously or on-the-fly, to be more than is accepted, e.g., a determination of whether the payment channel is directly accepted may be made just-in-time, may be dependent on other factors that may be static or dynamic, may be set by a user intervention or deduced from a set of provided instructions, and the like).

Referring again to FIG. 7, operation 700 may include operation 708 depicting negotiating a payment channel facilitation configured to facilitate at least a portion of the potential transaction in a manner in which, to at least one party to the potential transaction, the acquired payment channel appears to be used to carry out the potential transaction. For example, FIG. 2, e.g., FIG. 2B, shows facilitation of at least a portion of the potential transaction configured to provide an appearance of using the acquired payment channel to at least one party to the potential transaction negotiating module 258 negotiating (e.g., determining, selecting, facilitating, retrieving, receiving, or any other action that assists in choosing, selecting, creating, generating, and the like) a payment channel facilitation configured to facilitate (e.g., to take one or more steps to assist in the furtherance of, whether successful or not, including actions that record steps or create other steps, and actions that ultimately result in an unintended result) at least a portion of the potential transaction (e.g., an exchange of a form of compensation for goods and/or services, whether it actually occurs or not, at any stage, including preparation, selection of an item, verification of a price, verification of an identity, and equivalents) in a manner in which, to at least one party to the potential transaction (e.g., to the user/client who may be purchasing goods/services, or to the vendor who may be accepting payment, or any of their proxies, other entities, their devices, portions of their devices, or any other hardware, software, or other entity associated with the party) to the potential transaction, the acquired payment channel appears (e.g., this does not require that the party cannot find out that the acquired payment channel was not directly used for the entire potential transaction, but merely that at least one action was taken which gives the impression, either to a device or to a user of the device, that the acquired payment channel was used, whether that action is performed in actual furtherance of the transaction, or is performed as part of a device function, e.g., a particular display of a status to the party, or is performed merely as an illusory use of the acquired payment channel) to be used to carry out the potential transaction (e.g., the exchange of a form of compensation for goods and/or services, whether it actually occurs or not, at any stage, including preparation, selection of an item, verification of a price, verification of an identity, and equivalents).

FIGS. 8A-8C depict various implementations of operation 702, depicting receiving a potential transaction initiation request, said potential transaction initiation request configured to indicate an intent to carry out a potential transaction according to embodiments. Referring now to FIG. 8A, operation 702 may include operation 802 depicting receiving a potential transaction initiation request from a device, said potential transaction initiation request configured to indicate an intent of a user of the device to carry out a potential transaction. For example, FIG. 3, e.g., FIG. 3A, shows request for potential transaction initiation including indicator of intent to carry out potential transaction with a registered user of a device receiving from the device module 302 receiving a potential transaction initiation request (e.g., a data signal transmitted over a cellular network) from a device (e.g., a smartphone), said potential transaction initiation request (e.g., a data signal transmitted over a cellular network) configured to indicate an intent (e.g., the data signal transmitted over the cellular network includes a request to initiate the transaction) of a user of the device (e.g., a smartphone) to carry out a potential transaction (e.g., purchasing groceries).

Referring again to FIG. 8A, operation 802 may include operation 804 depicting receiving a potential transaction initiation request from a device associated with the user, said potential transaction initiation request including request data indicating a request to carry out the potential transaction. For example, FIG. 3, e.g., FIG. 3A, shows request for potential transaction initiation including indicator of intent to carry out potential transaction with a registered user of a device receiving from the device that is configured to be carried by the user module 304 receiving a potential transaction initiation request (e.g., a block of data that includes a request to purchase gasoline, and a set of payment channels available to the device) from a device (e.g., a motor vehicle control system in a motor vehicle) associated (e.g., driven by) with the user (e.g., a driver of a car), said potential transaction initiation request (e.g., the block of data that includes a request to purchase gasoline, and a set of payment channels available to the device) including request data indicating a request to carry out the potential transaction.

Referring again to FIG. 8A, operation 804 may include operation 806 depicting receiving the potential transaction initiation request from the device associated with the user, said potential transaction initiation request including request data indicating a request to submit payment for one or more items. For example, FIG. 3, e.g., FIG. 3A, shows request for potential transaction initiation including indicator of intent to carry out an exchange of currency and/or equivalents for goods and/or services with a registered user of a device receiving from the device that is configured to be carried by the user module 306 receiving the potential transaction initiation request (e.g., an audible sound emitted by the user device) associated with the user (e.g., a shopping cart picked up by a user upon entry to the store), said potential transaction initiation request including request data indicating a request to submit payment for one or more items (e.g., the items in the shopping cart).

Referring again to FIG. 8A, operation 806 may include operation 808 depicting receiving the potential transaction initiation request from the device associated with the user, said potential transaction initiation request including request data indicating a request to submit payment for one or more items using one or more of a particular payment modality and a particular payment option. For example, FIG. 3, e.g., FIG. 3A, shows request for potential transaction initiation including indicator of intent to carry out an exchange of currency and/or equivalents for goods and/or services using one or more of a particular payment modality and a particular payment option with a registered user of a device receiving from the device that is configured to be carried by the user module 308 receiving the potential transaction initiation request (e.g., receiving an indication from a component that detected a change in condition of the device) from the device (e.g., a smartphone) associated with the user (e.g., the customer), said potential transaction initiation request including request data indicating a request to submit payment for one or more items using one or more of a particular payment modality (e.g., credit card with swipe and signature) and a particular payment option (e.g., credit card from company Alpha).

Referring again to FIG. 8A, operation 808 may include operation 810 depicting receiving the potential transaction initiation request from the device associated with the user, said potential transaction initiation request including request data indicating a request to submit payment for one or more items using near-field communication. For example, FIG. 3, e.g., FIG. 3A, shows request for potential transaction initiation including indicator of intent to carry out an exchange of currency and/or equivalents for goods and/or services using near-field communication with a registered user of a device receiving from the device that is configured to be carried by the user module 310 receiving the potential transaction initiation request (e.g., a signal transmitted from a device) from the device (e.g., a tablet device, e.g., an Apple iPad) associated with (e.g., carried by) the user, said potential transaction initiation request including request data indicating a request to submit payment for one or more items using near-field communication.

Referring now to FIG. 8B, operation 702 may include operation 812 depicting receiving a potential transaction initiation request, said potential transaction initiation request configured to indicate a request to submit payment for an item. For example, FIG. 3, e.g., FIG. 3B, shows request for potential transaction initiation including indicator of intent to submit payment for one or more goods and/or services receiving module 312 receiving a potential transaction initiation request (e.g., a block of data indicating a request to use a particular payment channel to submit payment for goods), said potential transaction initiation request configured to indicate a request to submit payment for an item (e.g., an in-game purchase of extra lives for a character avatar).

Referring again to FIG. 8B, operation 812 may include operation 814 depicting receiving a potential transaction initiation request, said potential transaction initiation request configured to indicate an intent to purchase an item using one or more of a particular payment option and a particular payment modality. For example, FIG. 3, e.g., FIG. 3B, shows request for potential transaction initiation including indicator of intent to submit payment for one or more goods and/or services using one or more of a particular payment option and a particular payment modality receiving module 314 receiving a potential transaction initiation request (e.g., data indicating a request for more information about an item), said potential transaction initiation request configured to indicate an intent to purchase an item (e.g., requesting for more information about an item, in this context, may indicate intent to purchase an item) using one or more of a particular payment option (e.g., a debit card from bank alpha) and a particular payment modality (e.g., a debit card with PIN entry).

Referring again to FIG. 8B, operation 814 may include operation 816 depicting receiving the potential transaction initiation request, said potential transaction initiation request configured to indicate an intent to purchase an item using a particular payment option. For example, FIG. 3, e.g., FIG. 3B, shows request for potential transaction initiation including indicator of intent to submit payment for one or more goods and/or services using a particular payment option receiving module 316 receiving the potential transaction initiation request (e.g., the user getting into a particular position (e.g., towards the end of a store, or in line at a coffee shop), said potential transaction initiation request configured to indicate an intent to purchase an item using a particular payment option (e.g., the user gets in the “quickpass” line which uses the store's proprietary currency).

Referring again to FIG. 8B, operation 814 may include operation 818 depicting receiving the potential transaction initiation request, said potential transaction initiation request configured to indicate an intent to purchase an item using a particular payment modality. For example, FIG. 3, e.g., FIG. 3B, shows request for potential transaction initiation including indicator of intent to submit payment for one or more goods and/or services using a particular payment modality receiving module 318 receiving the potential transaction initiation request (e.g., the user touches a particular part of the retail counter), said potential transaction initiation request configured to indicate an intent to purchase an item (e.g., coffee from a coffee shop) using a particular payment modality (e.g., user identification via fingerprint and online account debiting after identification verification).

Referring again to FIG. 8B, operation 702 may include operation 820 depicting receiving a potential transaction initiation request from a device associated with a vendor, said potential transaction initiation request configured to indicate an intent to carry out a potential transaction. For example, FIG. 3, e.g., FIG. 3B, shows request for potential transaction initiation including indicator of intent to carry out potential transaction receiving from a vendor-associated device module 320 receiving a potential transaction initiation request from a device associated with a vendor (e.g., a near-field communication facilitating device, or an interfacing device that allows communication with specific branded phones, e.g., Apple phones), said potential transaction initiation request (e.g., data from the device indicating that the device has detected an intent of a user to carry out a potential transaction, and is transmitting that data to the vendor) configured to indicate an intent to carry out a potential transaction (e.g., buy toys at a toy store).

Referring again to FIG. 8B, operation 820 may include operation 822 depicting receiving the potential transaction initiation request from a device supplied by a payment channel provider and associated with the vendor, said potential transaction initiation request configured to indicate an intent to carry out the potential transaction. For example, FIG. 3, e.g., FIG. 3B, shows request for potential transaction initiation including indicator of intent to carry out potential transaction receiving from a vendor-associated device provided by a payment channel provider device module 322 receiving the potential transaction initiation request from a device supplied by a payment channel provider (e.g., it might be a specific payment option provider, e.g., MasterCard branded cards, or a BitCoin popularity generator, or it might be a general payment modality provider that works with a proprietary payment modality on particular devices, e.g., if a particular company developed a phone with a proprietary payment option or modality, and then that company would supply devices to vendors to interface with that company's phones that have the proprietary payment option or modality) and associated with (e.g., may be configured to transmit data to) the vendor, said potential transaction initiation request configured to indicate an intent to carry out the potential transaction (e.g., buying a college football preview magazine at a bookstore).

Referring again to FIG. 8B, operation 820 may include operation 824 depicting receiving the potential transaction initiation request from the device associated with a vendor in response to a user interacting with the device, said potential transaction initiation request configured to indicate the intent to carry out the potential transaction. For example, FIG. 3, e.g., FIG. 3B, shows request for potential transaction initiation including indicator of intent to carry out potential transaction receiving responsive to a user interaction detected by the vendor-associated device module 324 receiving the potential transaction initiation request from the device (e.g., a hotspot for scanning RFID or other similarly-equipped devices that store payment information) associated with a vendor (e.g., a device that is configured to transmit collected data to the vendor) in response to a user interacting with the device (e.g., a user holding their smartphone up to the device), said potential transaction initiation request configured to indicate the intent to carry out the potential transaction (e.g., to pay for the pizza slices).

Referring again to FIG. 8B, operation 824 may include operation 826 depicting receiving the potential transaction initiation request from the device associated with a vendor in response to a user inserting a credit card into the device, said potential transaction initiation request configured to indicate the intent to carry out the potential transaction. For example, FIG. 3, e.g., FIG. 3B, shows request for potential transaction initiation including indicator of intent to carry out potential transaction receiving responsive to a user entering a debit card personal identification number into vendor-associated device module 326 receiving the potential transaction initiation request from the device associated with a vendor in response to a user inserting a credit card into the device (e.g., a device that functions similarly to a credit card reader), said potential transaction initiation request configured to indicate the intent to carry out the potential transaction.

Referring again to FIG. 8B, operation 820 may include operation 828 depicting receiving the potential transaction initiation request from an input controller of the device associated with the vendor, said potential transaction initiation request configured to indicate an intent to carry out a potential transaction. For example, FIG. 3, e.g., FIG. 3B, shows request for potential transaction initiation including indicator of intent to carry out potential transaction receiving from an input/output component of the vendor-associated device module 328 receiving the potential transaction initiation request (e.g., a signal traveling through a device that indicates that a user has initiated a payment request, either explicitly, or implicitly, e.g., by taking an action that is detected by an augmented reality device worn by the user) from an input controller (e.g., a touchscreen control mechanism that processes inputs to the touchscreen) of the device (e.g., a terminal with a touchscreen) associated with the vendor (e.g., a grocery store), said potential transaction initiation request configured to indicate an intent to carry out a potential transaction (e.g., paying for groceries).

Referring now to FIG. 8C, operation 702 may include operation 830 depicting receiving the potential transaction initiation request generated in response to detection of a particular condition, said potential transaction initiation request configured to indicate the intent to carry out the potential transaction. For example, FIG. 3, e.g., FIG. 3C, shows request for potential transaction initiation generated in response to particular condition detection, including indicator of intent to carry out potential transaction, receiving module 330 receiving the potential transaction initiation request generated in response to detection of a particular condition (e.g., the user pressing a button of a device), said potential transaction initiation request configured to indicate the intent to carry out the potential transaction (e.g., the user paying for his meal at a restaurant, without leaving the table or requiring the server to take the user's credit card to the back, where it could be cloned, copied, or otherwise stolen).

Referring again to FIG. 8C, operation 830 may include operation 832 depicting receiving the potential transaction initiation request generated in response to detection of a particular condition related to a user, said potential transaction initiation request configured to indicate the intent to carry out the potential transaction. For example, FIG. 3, e.g., FIG. 3C, shows request for potential transaction initiation generated in response to user-based particular condition detection, including indicator of intent to carry out potential transaction, receiving module 332 receiving the potential transaction initiation request generated in response to detection of a particular condition (e.g., a user moves within ten feet of the store's exit), said potential transaction initiation request configured to indicate the intent to carry out the potential transaction (e.g., this is not the purely subjective “intent,” e.g., a user may intend in their mind to steal the item, but when they walk within ten feet of the exit, they intended to walk within ten feet of the exit, which is sufficient “intent” to trigger a transaction in particular circumstances, e.g., those listed above).

Referring again to FIG. 8C, operation 832 may include operation 834 depicting receiving the potential transaction initiation request generated in response to detection of a particular action taken by the user, said potential transaction initiation request configured to indicate the intent to carry out the potential transaction. For example, FIG. 3, e.g., FIG. 3C, shows request for potential transaction initiation generated in response to user-based action detection, including indicator of intent to carry out potential transaction, receiving module 334 receiving the potential transaction initiation request generated in response to detection of a particular action taken by the user (e.g., pressing a button on a terminal or other device), said potential transaction initiation request configured to indicate the intent to carry out the potential transaction (e.g., paying for popcorn at a movie theater from the movie seat).

Referring again to FIG. 8C, operation 834 may include operation 836 depicting receiving the potential transaction initiation request generated in response to detection of a particular action taken by the user to place an item in a shopping cart, said potential transaction initiation request configured to indicate an intent of the user to purchase the item in the shopping cart. For example, FIG. 3, e.g., FIG. 3C, shows request for potential transaction initiation generated in response to user-based movement of a particular item detection, including indicator of intent to carry out potential transaction, receiving module 336 receiving the potential transaction initiation request (e.g., a data stream) generated in response to detection of a particular action taken by the user to place an item in a shopping cart (e.g., which is detected by the shopping cart), said potential transaction initiation request configured to indicate an intent of the user to purchase the item in the shopping cart.

Referring again to FIG. 8C, operation 830 may include operation 838 depicting receiving the potential transaction initiation request generated in response to detection of a particular location of the user, said potential transaction initiation request configured to indicate the intent to carry out the potential transaction. For example, FIG. 3, e.g., FIG. 3C, shows request for potential transaction initiation generated in response to user-based location detection, including indicator of intent to carry out potential transaction, receiving module 338 receiving the potential transaction initiation request generated (e.g., generated by a device carried by the user) in response to detection of a particular location of the user (e.g., the user is in line at the sandwich shop), said potential transaction initiation request configured to indicate the intent to carry out the potential transaction.

Referring now to FIG. 8D, operation 702 may include operation 840 depicting receiving the potential transaction initiation request from a device associated with a user, said potential transaction initiation request configured to indicate the user's intent to carry out the potential transaction. For example, FIG. 3, e.g., FIG. 3D, shows request for potential transaction initiation including indicator of intent to carry out potential transaction receiving from a device that stores data regarding a user receiving module 340 receiving the potential transaction initiation request from a device associated with a user (e.g., a smartphone device owned by the user), said potential transaction initiation request configured to indicate the user's intent (e.g., the user wants to submit payment for her coffee drink) to carry out the potential transaction (e.g., paying for her coffee drink).

Referring again to FIG. 8D, operation 702 may include operation 842 depicting receiving potential transaction initiation request data, said potential transaction initiation request data including data indicating the intent to carry out the potential transaction. For example, FIG. 3, e.g., FIG. 3D, shows request for potential transaction initiation data including indicator data describing intent to carry out potential transaction receiving module 342 receiving potential transaction initiation request data (e.g., data that includes, among other things, a request to carry out the transaction, and may include further data, including transaction options, payment options, payment modalities, user identification, device identification, item identification, and the like), said potential transaction initiation request data including data indicating the intent to carry out the potential transaction (e.g., purchasing groceries at the grocery store).

FIGS. 9A-9F depict various implementations of operation 704, depicting acquiring potential transaction data that includes a request to use a particular payment channel for at least a portion of the potential transaction, according to embodiments. Referring now to FIG. 9A, operation 704 may include operation 902 depicting receiving the potential transaction data that includes a request to use a particular payment channel for at least a portion of the potential transaction. For example, FIG. 4, e.g., FIG. 4A, shows transaction data including request to utilize a particular payment channel for carrying out at least a portion of the potential transaction receiving module 402 receiving the potential transaction data (e.g., this data may take the form of general request data, or may be an attempt to use a particular payment channel, for which the request to use the particular payment channel may be inferred) that includes a request (e.g., either implicit or inferable (e.g., if the potential transaction data includes an attempt to use a particular payment channel, an inference can be made that this is a request to use the particular payment channel)) to use a particular payment channel (e.g., a payment modality of “fingerprint authentication for bank account information”) for at least a portion of (e.g., a portion in which payment is submitted) of the potential transaction (e.g., paying for items in a store that are not present at the store, or are present only as representations or models, but will be delivered to the user's desired location).

Referring again to FIG. 9A, operation 902 may include operation 904 depicting receiving the potential transaction data that includes a request to use a particular payment modality for at least a portion of the potential transaction. For example, FIG. 4, e.g., FIG. 4A, shows transaction data including request to utilize a particular payment modality for carrying out at least a portion of the potential transaction receiving module 404 receiving the potential transaction data (e.g., a request to use a particular payment modality, e.g., indirect device authentication via a device manufacturer network) that includes a request to use a particular payment modality (e.g., indirect device authentication via a device manufacturer network) for at least a portion of the potential transaction (e.g., paying for power tools and supplies at a home improvement store).

Referring again to FIG. 9A, operation 904 may include operation 906 depicting receiving, from a device, the potential transaction data that includes the request to use a near-field communication with a device tap for at least a portion of the potential transaction. For example, FIG. 4, e.g., FIG. 4A, shows transaction data including request to utilize a particular payment modality of near-field communication equipped device proximity contact sensor for carrying out at least a portion of the potential transaction receiving module 406 receiving, from a device (e.g., a tablet device carried by a user that is currently also running a word processing program listing a grocery list), the potential transaction data that includes the request to use a near-field communication with a device tap for at least a portion of the potential transaction (e.g., purchasing groceries at a grocery store).

Referring again to FIG. 9A, operation 906 may include operation 908 depicting receiving, from a device, the potential transaction data that includes the request to use the near field communication with the device tap for a portion of the potential transaction that includes paying for an ordered coffee drink by tapping the device at a particular location in a booth of a coffee shop. For example, FIG. 4, e.g., FIG. 4A, shows transaction data including request to utilize a particular payment modality of near-field communication equipped device proximity contact sensor for submitting payment for an ordered coffee drink receiving from a device module 408 receiving, from a device, the potential transaction data that includes the request to use the near field communication with the device tap for a portion of the potential transaction that includes paying for an ordered coffee drink by tapping the device at a particular location in a booth of a coffee shop.

Referring again to FIG. 9A, operation 902 may include operation 910 depicting receiving the potential transaction data from a device configured to register one or more potential transactions, said potential transaction data including the request to use the particular payment channel for the at least the portion of the potential transaction. For example, FIG. 4, e.g., FIG. 4A, shows transaction data including request to utilize a particular payment channel for carrying out at least a portion of the potential transaction receiving from a transaction logging device module 410 receiving the potential transaction data (e.g., data including multiple payment channels and an order of preference for use of those payment channels) from a device configured to register (e.g., detect, track, modify, inform of, or otherwise take one or more actions related to) one or more potential transactions (e.g., paying for items), said potential transaction data including the request to use the particular payment channel (e.g., device tap) for the at least the portion of the potential transaction (e.g., paying for items the user wishes to purchase).

Referring again to FIG. 9A, operation 704 may include operation 912 depicting generating potential transaction data that includes the request to use the particular payment channel for the at least the portion of the potential transaction. For example, FIG. 4, e.g., FIG. 4A, shows transaction data including request to utilize a particular payment channel for carrying out at least a portion of the potential transaction generating module 412 generating (e.g., based upon one or more of conditions, detected data, received data, etc., for example, visually detecting, through a camera and computer vision software, that a user has taken a credit card out of her wallet, and using that information to generate potential transaction data that includes the request to use that particular credit card as a payment option) that includes the request to use the particular payment channel (e.g., the particular credit card as a payment option) for the at least the portion of the potential transaction (e.g., purchasing electronics at a big-box electronics store).

Referring again to FIG. 9A, operation 912 may include operation 914 depicting generating potential transaction data, at least by partially inferring a request to use the particular payment channel for the at least the portion of the potential transaction. For example, FIG. 4, e.g., FIG. 4A, shows transaction data including request to utilize a particular payment channel for carrying out at least a portion of the potential transaction generating at least partially through inference based on received data module 414 generating potential transaction data, at least by partially inferring a request (e.g., through an attempt to use, for example, although other, less direct inferences could also be made) to use the particular payment channel (e.g., password and login information to an online bank account) for the at least the portion of the potential transaction (e.g., purchasing an eBook from an eBook reader).

Referring now to FIG. 9B, operation 704 may include operation 916 depicting receiving, from a device associated with a user, specific data. For example, FIG. 4, e.g., FIG. 4B, shows particular data that is generated by a device associated with a user receiving module 416 receiving, from a device (e.g., a tablet device, e.g., an Apple iPad) associated with a user (e.g., a person intending to carry out a transaction), specific data (e.g., a list of device capabilities from which a set of possible payment modalities and/or options can be inferred).

Referring again to FIG. 9B, operation 704 may include operation 918 depicting generating, at least partly based on the received specific data, potential transaction data that includes the request to use the particular payment channel for the at least the portion of the potential transaction. For example, FIG. 4, e.g., FIG. 4B, shows transaction data including the request to utilize a particular payment channel for carrying out at least a portion of the potential transaction generating at least partly based on the received particular data module 418 generating (e.g., creating a set of one or more payment options the user of a device can use), at least partly based on the received specific data (e.g., a list of device capabilities), potential transaction data that includes the request to use the particular payment channel (e.g., one of the payment options listed in the device) for the at least the portion of the potential transaction (e.g., paying for compact discs at a music store).

Referring again to FIG. 9B, operation 916 may include operation 920 depicting receiving, from the device, data indicating one or more payment options available to the user. For example, FIG. 4, e.g., FIG. 4B, shows particular data including a list of one or more device-supported payment options that is generated by the device associated with the user receiving module 420 receiving, from the device (e.g., a computer on a network that is remote from the user but is communicating with a user's smartphone device, which sends the signal to the user's remote computer to send the data), data indicating one or more payment options (e.g., transmitting credit information, which can be used to generate an instant credit approval as a payment option if conditions are met) available to the user.

Referring again to FIG. 9B, operation 920 may include operation 922 depicting receiving, from the device, data indicating a credit card payment option that is available to the user of the device. For example, FIG. 4, e.g., FIG. 4B, shows particular data including a list of one or more device-supported credit card payment options that is generated by the device associated with the user receiving module 422 receiving, from the device (e.g., a user's smartphone device), data indicating a credit card payment option that is available to the user of the device.

Referring again to FIG. 9B, operation 916 may include operation 924 depicting receiving, from the device, device data regarding one or more characteristics of the device. For example, FIG. 4, e.g., FIG. 4B, shows particular data about one or more properties of the device that is generated by the device associated with the user receiving module 424 receiving, from the device (e.g., a portable device given out to shoppers when they enter the store), device data regarding one or more characteristics of the device (e.g., a characteristic including that the device has stored items the user has selected in its memory).

Referring again to FIG. 9B, operation 924 may include operation 926 depicting receiving, from the device, device data regarding one or more data transmission protocols supported by the device. For example, FIG. 4, e.g., FIG. 4B, shows particular data about one or more supported data transmission protocols of the device that is generated by the device associated with the user receiving module 426 receiving, from the device, device data regarding one or more data transmission protocols supported by the device.

Referring again to FIG. 9B, operation 924 may include operation 928 depicting receiving, from the device, device data including a list of one or more payment channel data to which the device has access. For example, FIG. 4, e.g., FIG. 4B, shows particular data about one or more payment channel data accessible by the device that is generated by the device associated with the user receiving module 428 receiving, from the device (e.g., a smartphone device), device data including a list of one or more payment channel data (e.g., access to one or more bank accounts, one or more credit card accounts, one or more online shopping accounts) to which the device has access (e.g., has stored credentials for, or is authorized to access, or stores the data itself, or has access to a location where the data is stored).

Referring again to FIG. 9B, operation 924 may include operation 930 depicting receiving, from the device, device data including one or more device settings. For example, FIG. 4, e.g., FIG. 4B, shows particular data about one or device settings read by the device associated with the user receiving module 430 receiving, from the device (e.g., a tablet device), device data including one or more device settings (e.g., the device is configured to only connect to wireless networks that use a particular type of encryption, e.g., WEP-2 or stronger).

Referring now to FIG. 9C, operation 704 may include operation 932 depicting acquiring potential transaction data that is part of the potential transaction initiation request, that includes the request to use the particular payment channel for at least a portion of the potential transaction. For example, FIG. 4, e.g., FIG. 4C, shows transaction data that is part of the request for potential transaction initiation, said transaction data including request to utilize a particular payment channel for carrying out at least a portion of the potential transaction acquiring module 432 acquiring potential transaction data that is part of the potential transaction initiation request (e.g., the request in the form of data, e.g., data stating, colloquially “the user of this device wishes to purchase these goods using the payment modality of device tap with online account access one-time authorization), that includes the request to use the particular payment channel (e.g., the particular payment modality of device tap with online account access one-time authorization) for at least a portion of the potential transaction (e.g., purchasing a lawn mower at a Sears department store).

Referring again to FIG. 9C, operation 704 may include operation 934 depicting detecting potential transaction data that indicates a request to use the particular payment channel for at least a portion of the potential transaction. For example, FIG. 4, e.g., FIG. 4C, shows transaction data including request to utilize a particular payment channel for carrying out at least a portion of the potential transaction detecting module 434 detecting (e.g., receiving notification, either from an external source providing data, from an internal source (e.g., a sensor, or a microchip, or other component) providing a signal) potential transaction data (e.g., data indicating that a device has been instructed to begin carrying out a transaction, e.g., instructed by a user, although not necessarily by a user, and not necessarily explicitly instructed, e.g., a device inference is possible) that indicates a request to use the particular payment channel (e.g., an online store-specific rewards account, e.g., rewards points at Kmart/Sears department stores, e.g., which can be used for online shopping or physical store location shopping interchangeably) for at least a portion of the potential transaction (e.g., buying power tools from the tool section of a Sears department store).

Referring again to FIG. 9C, operation 704 may include operation 936 depicting acquiring potential transaction data that includes a request to use one or more of a particular payment option and a particular payment modality for at least a portion of the potential transaction. For example, FIG. 4, e.g., FIG. 4C, shows transaction data including request to utilize one or more of a particular payment option and a particular payment modality for carrying out at least a portion of the potential transaction detecting module 436 acquiring potential transaction data that includes a request to use one or more of a particular payment option (e.g., credit card alpha) and a particular payment modality (e.g., credit card RFID-based tap-and-go) for at least a portion of the potential transaction (e.g., paying for gasoline at a gas pump).

FIGS. 10A-10D depict various implementations of operation 706 depicting determining that the acquired particular payment channel includes a payment channel that is not directly accepted, according to embodiments. Referring now to FIG. 10A, operation 706 may include operation 1002 depicting determining that the acquired particular payment channel includes a particular payment modality that is not directly accepted. For example, FIG. 5, e.g., FIG. 5A, shows acquired particular payment channel including a particular payment modality absence from a set of one or more directly accepted payment channels determining module 502 determining that the acquired particular payment channel includes a particular payment modality (e.g., near-field communication) that is not directly accepted (e.g., is not accepted without a conversion, help from another resource, a special exemption, or the fulfillment of some other condition).

Referring again to FIG. 10A, operation 1002 may include operation 1004 depicting determining that the acquired particular payment channel includes a credit card with electronic signature recognition modality that is not directly accepted due to a lack of an electronic signature pad. For example, FIG. 5, e.g., FIG. 5A, shows acquired particular payment channel including a particular payment modality of using a credit card with electronic signature recognition absence from a set of one or more directly accepted payment channels determining module 504 determining that the acquired particular payment channel includes a credit card with electronic signature recognition modality that is not directly accepted due to a lack of an electronic signature pad.

Referring again to FIG. 10A, operation 706 may include operation 1006 depicting determining that the acquired particular payment channel includes a particular payment option that is not directly accepted. For example, FIG. 5, e.g., FIG. 5A, shows acquired particular payment channel including a particular payment option absence from a set of one or more directly accepted payment channels determining module 506 determining that the acquired particular payment channel includes a particular payment option (e.g., BitCoin transfer) that is not directly accepted (e.g., is not generally accepted, e.g., an exception would be made, or an external resource would be enlisted, in order to complete the transaction).

Referring again to FIG. 10A, operation 1006 may include operation 1008 depicting determining that the acquired particular payment channel includes a credit card sponsored by company alpha, that is not directly accepted because a vendor does not have a relationship with company alpha. For example, FIG. 5, e.g., FIG. 5A, shows acquired particular payment channel including a particular payment option of a credit card from a particular company absence from a set of one or more directly accepted payment channels determining module 508 determining that the acquired particular payment channel includes a credit card sponsored by company alpha, that is not directly accepted because a vendor does not have a relationship with company alpha (e.g., the vendor is not willing to agree to the percentage that credit card alpha takes of any transaction carried out using a credit card alpha).

Referring again to FIG. 10A, operation 706 may include operation 1010 depicting determining that the acquired particular payment channel includes a particular payment option and a particular payment modality, wherein one or more of the particular payment option and the particular payment modality are not directly accepted. For example, FIG. 5, e.g., FIG. 5A, shows acquired particular payment channel including a particular payment option and a particular payment modality absence from a set of one or more directly accepted payment channels determining module 510 determining that the acquired particular payment channel includes a particular payment option (e.g., a location-specific gift certificate, e.g., a gift certificate to a shopping center or a mall with many stores) and a particular payment modality (e.g., a store-issued pager that transmits data to a source), wherein one or more of the particular payment option (e.g., the location-specific gift certificate) and the particular payment modality (e.g., the store-issued pager that transmits data) are not directly accepted (e.g., are not accepted without an intermediary device to perform some additional processing).

Referring again to FIG. 10A, operation 706 may include operation 1012 depicting determining that the acquired particular payment channel is a payment channel that is not accepted under various circumstances. For example, FIG. 5, e.g., FIG. 5A, shows acquired particular payment channel absence from a set of one or more payment channels accepted when a particular condition is present determining module 512 determining that the acquired particular payment channel (e.g., device authentication to verify a user's identity and to draw on their store credit) is a payment channel that is not accepted under various circumstances (e.g., device authentication is only accepted when the user has a particular kind of device, e.g., an Apple-branded device, or a particular class of device, e.g., a smartphone device, but tablets are not accepted).

Referring again to FIG. 10A, operation 1012 may include operation 1014 depicting determining that the acquired payment channel is using an unencrypted wireless network to transmit payment information as a payment modality, and not accepting that payment channel directly or after relay through an intermediary. For example, FIG. 5, e.g., FIG. 5A, shows acquired particular payment channel absence from a set of one or more payment channels not accepted when an unencrypted channel is used determining module 514 determining that the acquired payment channel is using an unencrypted wireless network to transmit payment information as a payment modality, and not accepting that payment channel directly or after relay through an intermediary (e.g., if any step in the process uses an unencrypted network, the data is potentially compromised, and so the vendor will not accept the payment modality, to protect the user from identity theft and the like).

Referring now to FIG. 10B, operation 706 may include operation 1016 depicting determining that the acquired payment channel is a payment channel that is not accepted as originally transmitted from the source. For example, FIG. 5, e.g., FIG. 5A, shows acquired particular payment channel absence from a set of one or more accepted as originally transmitted from a source payment channels determining module 516 determining that the acquired payment channel is a payment channel (e.g., Bluetooth transmission as a payment modality) that is not accepted as originally transmitted from the source (e.g., the vendor may not take Bluetooth, but if another device can relay the data using a different payment modality, then payment may be accepted).

Referring again to FIG. 10B, operation 706 may include operation 1018 depicting determining that the acquired payment channel is a payment channel that is not accepted in a form that is requested by the requestor. For example, FIG. 5, e.g., FIG. 5A, shows acquired particular payment channel absence from a set of one or more accepted in a source-requested format payment channels determining module 518 determining that the acquired payment channel is a payment channel (e.g., debit card from bank kappa) that is not accepted in a form that is requested by the requestor (e.g., the vendor does not take debit from bank kappa, but may have an agreement with a different bank delta, which bank delta may have an agreement with bank kappa to make payment to the vendor from bank delta and collect from bank kappa, or similarly, a device that has access to both bank delta and bank kappa may make a similar agreement).

Referring again to FIG. 10B, operation 706 may include operation 1020 depicting transmitting the acquired payment channel to an external resource. For example, FIG. 5, e.g., FIG. 5A, shows acquired particular payment channel transmitting to an external resource module 520 transmitting the acquired payment channel (e.g., the acquired payment option, e.g., insurance card delta, to pay for a prescription drug) to an external resource (e.g., transmitting to a central server (e.g., which may track all transactions from multiple stores) to determine whether that particular insurance card is accepted (e.g., also, in an embodiment, the insurance company itself may be contacted).

Referring again to FIG. 10B, operation 706 may include operation 1022 depicting receiving a determination from the external resource regarding whether the payment channel is directly accepted. For example, FIG. 5, e.g., FIG. 5B, shows determination regarding absence of the acquired particular payment channel from the set of one or more directly accepted payment channels receiving module 522 receiving a determination from the external resource (e.g., the central server connected to all the stores in the area) regarding whether the payment channel (e.g., the acquired payment option, insurance card delta) is directly accepted.

Referring again to FIG. 10B, operation 1020 may include operation 1024 depicting transmitting the acquired payment channel to an external resource that is selected based on the acquired payment channel. For example, FIG. 5, e.g., FIG. 5B, shows acquired particular payment channel transmitting to an external resource selected at least partly based on one or more properties of the acquired particular payment channel module 524 transmitting the acquired payment channel (e.g., debit card delta as a payment option) to an external resource (e.g., a website for the bank that supports debit card delta) that is selected based on the acquired payment channel (e.g., the acquired payment option informs the system which bank to check to determine whether the payment option is allowed).

Referring again to FIG. 10B, operation 706 may include operation 1026 depicting retrieving a list of one or more directly accepted payment channels. For example, FIG. 5, e.g., FIG. 5B, shows set of one or more directly accepted payment channels receiving module 526 retrieving (e.g., obtaining, from memory, internal or external, from an input/output device, or from a remote location, e.g., a remote server or website) a list of one or more directly accepted payment channels (e.g., one or more payment options and modalities), e.g., the list may change depending on conditions (e.g., for a store credit payment modality, that may be accepted on some days and not on others, depending on current finances and cash flows, for example).

Referring again to FIG. 10B, operation 706 may include operation 1028 depicting determining that the acquired particular payment channel is a payment channel that is not directly accepted by comparing the acquired particular payment channel to the retrieved list of one or more directly accepted particular payment channels. For example, FIG. 5, e.g., FIG. 5B, shows acquired particular payment channel to at least one of the payment channels present in the received set of one or more directly accepted payment channels comparing module 528 determining that the acquired payment channel (e.g., request for store credit using a device submission of a credit score as a payment modality) is a payment channel that is not directly accepted by comparing the acquired particular payment channel (e.g., the request for store credit using a device submission of a credit score as a payment modality) to the retrieved list of one or more directly accepted particular payment channels.

Referring now to FIG. 10C, operation 706 may include operation 1030 depicting polling one or more devices to determine if the one or more devices use the acquired payment channel. For example, FIG. 5, e.g., FIG. 5C, shows acquired particular payment channel absence from a set of one or more directly accepted payment channels determining by polling one or more devices module 530 polling (e.g., contacting in a regular fashion, contacting with a specific request for information, determining a presence of, or any other form of communication) one or more devices (e.g., polling al of the laptop devices in a coffee shop) to determine if the one or more devices use the acquired payment channel (e.g., 60 GHz spectrum band wireless communication).

Referring again to FIG. 10C, operation 706 may include operation 1032 depicting polling one or more device components to determine if the one or more device components are sufficient to accept the acquired payment channel. For example, FIG. 5, e.g., FIG. 5C, shows acquired particular payment channel absence from a set of one or more directly accepted payment channels determining by processing data regarding one or more device components of a vendor device module 532 polling one or more device components (e.g., applications on the device, or I/O components of the device, or any other hardware, software, or firmware, including the kernel and/or operating system) to determine if the one or more device components are sufficient (e.g., do the device components, either alone or in combination, allow the system to accept the acquired payment channel) to accept the acquired payment channel.

FIG. 11 depicts various implementations of operation 708 depicting negotiating a payment channel facilitation configured to facilitate at least a portion of the potential transaction in a manner in which, to at least one party to the potential transaction, the acquired payment channel appears to be used to carry out the potential transaction, according to embodiments. Referring now to FIG. 11, e.g., FIG. 11A, operation 708 may include operation 1102 depicting obtaining one or more resources that will allow facilitation of the potential transaction in a manner which will allow a user device to appear to use the acquired payment channel to carry out the potential transaction. For example, FIG. 6, e.g., FIG. 6A, shows one or more resources designed to allow execution of at least a portion with an appearance of using the acquired payment channel to at least one party acquiring module 602 obtaining one or more resources (e.g., a database, or a location of a database, or a device, or a component of a device, or a device connected to the system by a network, or a location or credential of any of these that will allow or facilitate access) that will allow facilitation of the potential transaction (e.g., paying for groceries at a grocery store) in a manner which will allow a user device (e.g., a user's smartphone) to appear to use the acquired payment channel (e.g., a payment modality of encrypted wireless network communication to transfer payment information) to carry out the potential transaction (e.g., paying for the user's groceries).

Referring again to FIG. 11A, operation 708 may include operation 1104 depicting instructing a user device to obtain transaction data at least partly using the acquired payment channel. For example, FIG. 6, e.g., FIG. 6A shows instruction to a user device to obtain transaction data at least partly using the acquired particular payment channel transmitting module 604 instructing a user device to obtain transaction data (e.g., data that will facilitate completion of a transaction, e.g., a credit card number) at least partly using the acquired payment channel (e.g., the acquired payment channel is “credit card number entry only, but the vendor requires a signature, so the vendor is going to also get, from the user device, access to the user's cloud drive, where an image file of the user's signature is stored, and the acquired payment modality is infrared beam transmission).

Referring again to FIG. 11A, operation 708 may include operation 1106 depicting instructing the user device to convert the transaction data into a format configured to be used with an alternate payment channel. For example, FIG. 6, e.g., FIG. 6A, shows instruction to a user device to manipulate obtained transaction data into a format configured to be used with a payment channel other than the particular payment channel transmitting module 606 instructing the user device to convert the transaction data (e.g., the credit card data) into a format (e.g., the user device codes the data into a form that can be easily used in an infrared beam transmission, and transmits that data to a device that has an infrared beam transmission, which receives the data from the device and beams it to the vendor) configured to be used with an alternate payment channel (e.g., infrared beam transmission, which is accepted by the vendor).

Referring again to FIG. 11A, operation 708 may include operation 1108 depicting facilitating the potential transaction with the user device using the alternate payment channel. For example, FIG. 6, e.g., FIG. 6A, shows potential transaction facilitating at least partly using the further payment channel module 608 facilitating the potential transaction (e.g., paying for a coffee drink at a coffee shop) with the user device using the alternate payment channel (e.g., infrared beam transmission).

Referring again to FIG. 11A, operation 1104 may include operation 1110 depicting instructing the user device to obtain transaction data from the acquired payment channel, in order to appear to the user that the acquired payment channel is used to carry out the potential transaction. For example, FIG. 6, e.g., FIG. 6A, shows instruction to a user device to obtain transaction data at least partly using the acquired particular payment channel, so that an appearance of using the acquired particular payment channel to at least one party to the potential transaction is generated transmitting module 610 instructing the user device to obtain transaction data (e.g., obtain a user's bank access code) from the acquired payment channel (e.g., the use of bank delta as a payment option), in order to appear to the user that the acquired payment channel is used (e.g., the bank delta account will be debited, but the debiting will be done by a third party that has an agreement to debit the bank delta, and then to pay the vendor using a different payment option, e.g., bank gamma) is used to carry out the potential transaction (e.g., purchasing cigars for smoking at a cigar shop).

Referring again to FIG. 11A, operation 1106 may include operation 1112 depicting providing the user device with one or more resources for converting the payment data into a format configured to be used with an alternate payment channel. For example, FIG. 6, e.g., FIG. 6A, shows one or more resources configured to assist in manipulating obtained transaction data into a format configured to be used with a further payment channel other than the particular payment channel providing to the user device module 612 providing the user device with one or more resources for converting the payment data (e.g., providing the user device with a conversion table, or with permission to access a different bank) into a format configured to be used with an alternate payment channel (e.g., a different credit card than the one the user would prefer to use).

Referring again to FIG. 11A, operation 1112 may include operation 1114 depicting providing the user device with a database of vendor product codes for converting pictographic data of a product intended to be purchased into a vendor-recognized vendor product code. For example, FIG. 6, e.g., FIG. 6A, shows database of vendor product codes configured to assist in manipulating obtained transaction data into a format configured to be used with a further payment channel other than the particular payment channel providing to the user device module 614 providing the user device (e.g., a user's smartphone device) with a database of vendor product codes for converting pictographic data of a product intended to be purchased into a vendor-recognized vendor product code.

Referring again to FIG. 11A, operation 608 may include operation 1116 depicting facilitating the potential transaction with the user device using the alternate payment channel, said facilitating occurring without notification to a user of the user device. For example, FIG. 6, e.g., FIG. 6A, shows potential transaction facilitating at least partly using the further payment channel without providing notification to a user of the use of the further payment channel module 616 facilitating the potential transaction (e.g., paying for a drink order at a bar) with the user device (e.g., a user's custom bar-tab device that was handed to the user when he entered the bar) using the alternate payment channel (e.g., a bar tab being kept by the bar, when the acquired payment channel is “credit card alpha,” but the bar doesn't want to make too many accesses to credit card alpha to reduce the chance of an interception of sensitive data, so the bar tab is debited, and then the credit card is billed at the end of the night), said facilitating occurring without notification (e.g., without giving a particular visual, audio, or other sensory cue) that the alternate payment channel is being used, to a user of the user device (e.g., the bar-tab device).

Referring now to FIG. 11B, operation 708 may include operation 1118 depicting determining one or more resources configured to facilitate at least a portion of the potential transaction. For example, FIG. 6, e.g., FIG. 6B, shows one or more resources configured to facilitate at least a portion of the potential transaction determining module 618 determining one or more resources (e.g., an external server at a remote location that is provided by a manufacturer of the device carried by the user as a selling point, e.g., a promise to facilitate transactions even when the preferred payment modalities are not accepted by the vendor) configured to facilitate at least a portion of the potential transaction (e.g., configured to accept the acquired payment channel).

Referring again to FIG. 11B, operation 708 may include operation 1120 depicting transmitting data regarding the one or more determined resources to a user device configured to use the acquired payment channel. For example, FIG. 6, e.g., FIG. 6B, shows data regarding the one or more determined resources transmitting to a user device configured to use the particular payment channel module 620 transmitting data regarding the one or more determined resources (e.g., transmitting the go-ahead to use the external server provided by the manufacturer of the device, or in a different embodiment where the external resource is vendor-provided and not user device-provided, transmitting data providing authorization, credentials, or the address of the resource) to a user device (e.g., a user's laptop device) configured to use the acquired payment channel (e.g., a payment modality of “device authentication and transmission of credit score for instant credit approval”).

Referring again to FIG. 11B, operation 1118 may include operation 1122 depicting determining one or more resources configured to be used to carry out at a first portion of the potential transaction using the acquired payment channel and to carry out a second portion of the potential transaction using an alternate payment channel, wherein the alternate payment channel is directly accepted. For example, FIG. 6, e.g., FIG. 6B, shows one or more resources configured to facilitate a first portion of the potential transaction using the particular payment channel and to facilitate a second portion of the potential transaction using an alternate payment channel that is present in the set of one or more directly accepted payment channels determining module 622 determining one or more resources (e.g., an intermediary device located by the vendor) configured to be used to carry out a first portion of the potential transaction (e.g., acquiring payment information from the user device) using the acquired payment channel (e.g., a payment modality of credit card with PIN and billing zip code entry, and a payment option of credit card gamma), and to carry out a second portion of the potential transaction (e.g., providing payment to the vendor) using an alternate payment channel (e.g., a payment modality of credit card with PIN only, and a payment option of credit card omega), wherein the alternate payment channel (e.g., the payment modality of credit card with PIN only, and a payment option of credit card omega) is directly accepted (e.g., the vendor accepts credit card with PIN only as a payment modality, and accepts credit card omega as a payment option, e.g., both the payment modality and the payment option are part of the directly accepted vendor payment channel set).

Referring again to FIG. 11B, operation 1122 may include operation 1124 depicting determining one or more devices configured to directly accept both of the acquired payment channel and the alternate payment channel. For example, FIG. 6, e.g., FIG. 6B, shows one or more devices configured to directly accept both the acquired particular payment channel and the further payment channel that is present in the set of one or more directly accepted payment channels determining module 624 determining one or more devices (e.g., smartphone devices, laptops, tablet devices, etc.) configured to directly accept both of the acquired payment channel (e.g., BitCoins as a payment option) and the alternate payment channel (e.g., device tap as a payment modality).

Referring again to FIG. 11B, operation 1124 may include operation 1126 depicting receiving a list of one or more devices configured to directly accept both of the acquired payment channel and the alternate payment channel. For example, FIG. 6, e.g., FIG. 6B, shows list of one or more devices configured to directly accept both the acquired particular payment channel and the further payment channel that is present in the set of one or more directly accepted payment channels generating module 626 receiving a list of one or more devices (e.g., three smartphones located in the vicinity of the grocery store) configured to directly accept both of the acquired payment channel (e.g., a payment option of credit card omega and a payment modality of credit card swipe+signature) and the alternate payment channel (e.g., a payment option of credit card delta and a payment modality of credit card+PIN entry).

Referring again to FIG. 11B, operation 1124 may include operation 1128 depicting selecting at least one device from the list of one or more devices. For example, FIG. 6, e.g., FIG. 6B, shows particular device from the list of one or more devices selecting module 628 selecting at least one device (e.g., one of the smartphones, e.g., a Samsung Galaxy S4) from the list of one or more devices (e.g., the list of three smartphones located in the vicinity of the grocery store).

Referring again to FIG. 11B, operation 1124 may include operation 1130 depicting determining one or more devices within a particular proximity of one or more parties to the particular transaction, said one or more devices configured to directly accept both of the acquired payment channel and the alternate payment channel. For example, FIG. 6, e.g., FIG. 6B, shows one or more devices within a particular proximity to a relevant entity configured to directly accept both the acquired particular payment channel and the further payment channel that is present in the set of one or more directly accepted payment channels determining module 630 determining one or more devices within a particular proximity (e.g., within 100 feet of) one or more parties to the particular transaction (e.g., to a particular area of the vendor, e.g., to the cash register area of the vendor, or simply in the vendor's store, for example, or proximity to the user's device, e.g., at the same table as, or within the same store as, e.g., there may be overlap between what is in proximity to the vendor and what is in proximity to the client).

Referring now to FIG. 11C, operation 1124 may include operation 1132 depicting polling at least one device having a particular characteristic to determine one or more devices configured to directly accept both of the acquired payment channel and the alternate payment channel. For example, FIG. 6, e.g., FIG. 6C, shows one or more devices having a particular property polling to determine at least one device configured to directly accept both the acquired particular payment channel and the further payment channel that is present in the set of one or more directly accepted payment channels module 632 polling at least one device having a particular characteristic (e.g., devices that support near-field communication) to determine one or more devices configured to directly accept both of the acquired payment channel (e.g., 256-bit encrypted wireless network communication as a payment modality) and the alternate payment channel (e.g., near field communication as a payment modality).

Referring again to FIG. 11C, operation 1132 may include operation 1134 depicting polling at least one device within a particular proximity to a particular location, to determine one or more devices configured to directly accept both of the acquired payment channel and the alternate payment channel. For example, FIG. 6, e.g., FIG. 6C, shows one or more devices having a particular location property polling to determine at least one device configured to directly accept both the acquired particular payment channel and the further payment channel that is present in the set of one or more directly accepted payment channels module 634 polling at least one device (e.g., a tablet device) within a particular proximity to a particular location (e.g., a payment station for a vendor of coffee drinks), to determine one or more devices (e.g., one or more tablet devices) configured to directly accept both of the acquired payment channel (e.g., online bank account, e.g., PayPal, transaction as a payment option) and the alternate payment channel (e.g., direct debiting of a bank account as a payment option).

Referring again to FIG. 11C, operation 1132 may include operation 1136 depicting polling at least one device communicating over a particular communication network, to determine one or more devices configured to directly accept both of the acquired payment channel and the alternate payment channel. For example, FIG. 6, e.g., FIG. 6C, shows one or more devices connected to a particular communication network polling to determine at least one device configured to directly accept both the acquired particular payment channel and the further payment channel that is present in the set of one or more directly accepted payment channels module 636 polling at least one device communicating over a particular communication network (e.g., a Verizon 4G LTE cellular network), to determine one or more devices (e.g., smartphone cellular devices) configured to directly accept both of the acquired payment channel (e.g., numbered traveler's checks as a payment option) and the alternate payment channel (e.g., credit card beta as a payment option).

Referring now to FIG. 11D, operation 1132 may include operation 1138 depicting polling at least one device manufactured by a particular manufacturer, to determine one or more devices configured to directly accept both of the acquired payment channel and the alternate payment channel. For example, FIG. 6, e.g., FIG. 6D, shows one or more devices manufactured by a particular manufacturer polling to determine at least one device configured to directly accept both the acquired particular payment channel and the further payment channel that is present in the set of one or more directly accepted payment channels module 638 polling at least one device manufactured by a particular manufacturer (e.g., Apple-branded devices), to determine one or more devices configured to directly accept both of the acquired payment channel (e.g., bank debit card gamma as a payment option) and the alternate payment channel (e.g., Apple-branded account points or credits accepting as a payment option).

Referring now to FIG. 11E, operation 708 may include operation 1140 depicting determining a resource that is configured to facilitate at least a portion of the potential transaction using the acquired payment channel. For example, FIG. 6, e.g., FIG. 6E, shows a resource configured to facilitate at least a portion of the potential transaction configured to provide an appearance of using the acquired particular payment channel to at least one party to the potential transaction locating module 640 determining a resource (e.g., an intermediary device that sits on the vendor's counter and uses a new form of device communication called “Green Lightning” (e.g., this is hypothetical, no such protocol exists at the time of filing, and any similarity between this hypothetical protocol and a real protocol is strictly coincidental) that a particular vendor is distributing in order to try to get the device protocol adopted by more devices) that is configured to facilitate at least a portion of the potential transaction (e.g., paying for ice cream at an ice cream store) using the acquired payment channel (e.g., the user wants to use “Green Lightning” as a payment modality due to its increased security and identity verification features).

Referring again to FIG. 11E, operation 708 may include operation 1142 depicting requesting assistance from the determined resource in facilitating the potential transaction. For example, FIG. 6, e.g., FIG. 6E, shows located resource configured to facilitate at least the portion of the potential transaction assistance requesting module 642 requesting assistance (e.g., requesting interaction with the user using the Green Lightning interface) from the determined resource (e.g., the intermediary device given to the vendor by a third party) in facilitating the potential transaction (e.g., paying for ice cream).

Referring again to FIG. 11E, operation 1140 may include operation 1144 depicting determining a resource that is configured to facilitate at least a portion of the potential transaction using the acquired payment channel, at least partly based on the acquired payment channel. For example, FIG. 6, e.g., FIG. 6E, shows a resource configured to facilitate at least a portion of the potential transaction configured to provide an appearance of using the acquired particular payment channel to at least one party to the potential transaction locating at least partly based on a property of the acquired particular payment channel module 644 determining a resource (e.g., an intermediary device owned by a different user that has a relationship to the user carrying out the transaction) that is configured to facilitate at least a portion of the potential transaction (e.g., paying for a video game at a video game store) using the acquired payment channel (e.g., device verification for family-shared account debiting), at least partly based on the acquired payment channel (e.g., the acquired payment modality, e.g., “find my trusted device that stores the actual payment information,” allows the vendor to find a trusted device, e.g., owned by a child's mother, and verifying the purchase and obtaining the credit card information from the mother, thus the child can use her device to pick out a video game, and it can be authorized by the mother, who has access to a credit card account and who wants to keep tabs on her child's spending).

Referring again to FIG. 11E, operation 1142 may include operation 1146 depicting requesting that the determined resource contact the party to the transaction to facilitate a portion of the potential transaction using the acquired payment channel. For example, FIG. 6, e.g., FIG. 6E, shows request for located resource to contact a party to the transaction transmitting module 646 requesting that the determined resource (e.g., the another user's cellular smartphone device) contact the party to the transaction (e.g., the user who wishes to purchase groceries) to facilitate a portion of the potential transaction (e.g., paying for groceries) using the acquired payment channel (e.g., credit card delta as a payment option, which the user needs the other user's cellular smartphone device to act as an intermediary in order for the store to complete the transaction, since the store does not directly accept credit card delta).

Referring now to FIG. 11F, operation 708 may include operation 1148 depicting selecting an intermediary device having a particular characteristic, said intermediary device configured to facilitate at least a portion of the potential transaction. For example, FIG. 6, e.g., FIG. 6F, shows intermediary device having a particular property and configured to facilitate at least a portion of the potential transaction selecting module 648 selecting an intermediary device having a particular characteristic (e.g., the intermediary device is manufactured by Samsung), said intermediary device configured to facilitate at least a portion of the potential transaction (e.g., purchasing concessions from a seat at a baseball game).

Referring again to FIG. 11F, operation 708 may include operation 1150 depicting negotiating an agreement with the intermediary device to facilitate at least a portion of the potential transaction. For example, FIG. 6, e.g., FIG. 6F, shows agreement with the intermediary device to facilitate at least a portion of the potential transaction managing device 650 negotiating (e.g., providing one or more parameters for, whether formally (e.g., contract) or informally) an agreement with the intermediary device (e.g., an external user device belonging to a user unrelated to the user involved in the transaction) to facilitate at least a portion of the potential transaction (e.g., to accept payment data from a user device using a payment channel that is not directly accepted, and to provide payment data to the vendor using a payment channel that is directly accepted).

Referring again to FIG. 11F, operation 708 may include operation 1152 depicting transmitting data regarding the intermediary device to a user device that has requested to use the payment channel. For example, FIG. 6, e.g., FIG. 6F, shows data regarding the intermediary device transmitting to a user device associated with the at least one party to the potential transaction transmitting module 652 transmitting data (e.g., location data, or authentication data) regarding the intermediary device (e.g., the external user device belonging to a user unrelated to the user involved in the transaction) to a user device that has requested to use the payment channel (e.g., a payment option of credit card gamma).

Referring again to FIG. 11F, operation 1148 may include operation 1154 depicting selecting an intermediary device configured to accept the particular payment channel. For example, FIG. 6, e.g., FIG. 6F, shows intermediary device configured to interface with the acquired particular payment channel and configured to facilitate at least a portion of the potential transaction selecting module 654 selecting an intermediary device (e.g., external user device belonging to a user unrelated to the user involved in the transaction) configured to accept the particular payment channel (e.g., online bank account, e.g., PayPal, as a payment option).

Referring again to FIG. 11F, operation 1148 may include operation 1156 depicting selecting an intermediary device configured to accept the particular payment channel and configured to accept an alternate payment channel. For example, FIG. 6, e.g., FIG. 6F, shows intermediary device configured to interface with the acquired particular payment channel and to interface with a further payment channel present in the set of one or more directly accepted payment channels determining module selecting module 656 selecting an intermediary device (e.g., a different user's device) configured to accept the particular payment channel (e.g., a payment modality of near-field communication) and configured to accept an alternate payment channel (e.g., a payment modality of reading a bar code).

Referring again to FIG. 11F, operation 1148 may include operation 1158 depicting selecting an intermediary device having a preexisting agreement with one or more vendors to facilitate one or more potential transactions. For example, FIG. 6, e.g., FIG. 6F, shows intermediary device having a preexisting vendor agreement and configured to facilitate at least a portion of the potential transaction selecting module 658 selecting an intermediary device having a preexisting agreement with one or more vendors (e.g., a vendor of the store trying to complete the potential transaction) to facilitate one or more potential transactions (e.g., buying tools at a hardware store).

Referring now to FIG. 11G, operation 1148 may include operation 1160 depicting selecting an intermediary device that is manufactured by a particular manufacturer, said intermediary device configured to facilitate at least a portion of the potential transaction. For example, FIG. 6, e.g., FIG. 6G, shows intermediary device having at least one component provided by a particular provider and configured to facilitate at least a portion of the potential transaction selecting module 660 selecting an intermediary device that is manufactured by a particular manufacturer (e.g., a Samsung tablet or smartphone device), said intermediary device configured to facilitate at least a portion of the potential transaction (e.g., purchasing a smoothie from a specialty drink shop).

Referring again to FIG. 11G, operation 1148 may include operation 1162 depicting selecting an intermediary device that is configured to run a particular operating system, said intermediary device configured to facilitate at least a portion of the potential transaction. For example, FIG. 6, e.g., FIG. 6G, shows intermediary device having a particular application stored in memory and configured to facilitate at least a portion of the potential transaction selecting module 662 selecting an intermediary device that is configured to run a particular operating system (e.g., Android operating system, or iOS, or Windows Phone operating system), said intermediary device configured to facilitate at least a portion of the potential transaction (e.g., purchasing groceries from a grocery store).

Referring again to FIG. 11G, operation 1150 may include operation 1164 depicting agreeing to provide the intermediary device with compensation in return for facilitating at least a portion of the potential transaction. For example, FIG. 6, e.g., FIG. 6G, shows compensation level for intermediary device to facilitate at least a portion of the potential transaction managing device setting module 664 agreeing (e.g., providing assent, which in some embodiments may be done electronically or without human intervention) to provide the intermediary device with compensation in return for facilitating at least a portion of the potential transaction.

Referring again to FIG. 11G, operation 1164 may include operation 1166 depicting agreeing to provide the intermediary device with a percentage of a sales price of the potential transaction, in return for facilitating at least a portion of the potential transaction. For example, FIG. 6, e.g., FIG. 6G, shows percentage of sale as compensation for intermediary device to facilitate at least a portion of the potential transaction managing device setting module 666 agreeing to provide the intermediary device (e.g., a smartphone of another person who is also in the store) with a percentage of a sales price of the potential transaction, in return for facilitating at least a portion of the potential transaction (e.g., paying for a coffee drink without getting up from a table).

Referring now to FIG. 11H, operation 1150 may include operation 1168 depicting verifying a preexisting agreement between the intermediary device and another party, to facilitate at least a portion of the potential transaction. For example, FIG. 6, e.g., FIG. 6G, shows preexisting agreement for intermediary device to facilitate at least a portion of the potential transaction managing device verifying module 668 verifying (e.g., confirming with a third party (e.g., the another party, e.g., the device operating system provider that has the agreement with the device) the existence of) a preexisting agreement (e.g., an agreement made prior to the time at which the potential transaction was initiated) between the intermediary device (e.g., a smartphone running a particular operating system, e.g., Microsoft's “Windows Phone 8” operating system) and another party (e.g., Microsoft, the owner of the operating system), to facilitate at least a portion of the potential transaction (e.g., purchasing groceries at the grocery store).

Referring again to FIG. 11H, operation 1168 may include operation 1170 depicting verifying a preexisting agreement between the intermediary device and a provider of one or more services to the intermediary device, to facilitate at least a portion of the potential transaction. For example, FIG. 6, e.g., FIG. 6H, shows preexisting agreement between a nonparty to the potential transaction and the intermediary device to facilitate at least a portion of the potential transaction managing device verifying module 670 verifying (e.g., confirming an existence of) a preexisting agreement (e.g., an agreement made at some other time than immediately prior to the verification) between the intermediary device (e.g., a cellular device carried by the user and running an app that facilitates these transactions, e.g., “IntermediApp” and a provider of one or more services (e.g., a provider of the “IntermediApp” app, but it could also be a provider of other, unrelated apps or services to the device, e.g., it could be a provider of particular network service, or reduced-rate pay network service, or some other unrelated service, e.g., a music tagging service, or the like), to facilitate at least a portion of the potential transaction (e.g., buying a cupcake from a cupcake truck).

Referring again to FIG. 11H, operation 1152 may include operation 1172 depicting transmitting an address of the intermediary device to a user device that has requested to use the particular payment channel. For example, FIG. 6, e.g., FIG. 6H, shows address of the intermediary device transmitting to a user device associated with the at least one party to the potential transaction transmitting module 672 transmitting an address (e.g., an IP address) of the intermediary device (e.g., a tablet held by another user in the same coffee shop as the user involved in the potential transaction) to a user device that has requested to use the particular payment channel (e.g., strong-encrypted wireless network data transmission as a payment modality).

Referring again to FIG. 11H, operation 1152 may include operation 1174 depicting transmitting a verification code used by the intermediary device to the user device that has requested to use the particular payment channel, said verification code configured to be used to verify an identity of the intermediary device. For example, FIG. 6, e.g., FIG. 6H, shows identity verification code used by intermediary device transmitting to the user device associated with the at least one party to the potential transaction transmitting module 674 transmitting a verification code (e.g., a passcode that is given only to the intermediary device, so that the intermediary device can verify itself to the user's device prior to accepting the user's personal information from the device) to the user device (e.g., the user's smartphone) that has requested to use the particular payment channel, said verification code configured to be used to verify an identity of the intermediary device (e.g., to verify that “this is the authentic device that's going to help complete the transaction,” and, in an embodiment, may, but is not required to, specifically identify the intermediary device (e.g., in some embodiments, it may be better to keep the device anonymous).

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in an embodiment,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

What is claimed is:

1-169. (canceled)

170. A device, comprising:
a request for potential transaction initiation including indicator of intent to carry out potential transaction receiving module;
a transaction data including request to utilize a particular payment channel for execution of at least a portion of the potential transaction acquiring module;
an acquired particular payment channel absence from a set of one or more directly accepted payment channels determining module; and
a facilitation of at least a portion of the potential transaction configured to provide an appearance of using the acquired particular payment channel to at least one party to the potential transaction negotiating module.

171. The device of claim 170, wherein said request for potential transaction initiation including indicator of intent to carry out potential transaction receiving module comprises:
a request for potential transaction initiation including indicator of intent to carry out potential transaction with a registered user of a device receiving from the device module.

172. (canceled)

173. (canceled)

174. (canceled)

175. (canceled)

176. (canceled)

177. (canceled)

178. (canceled)

179. (canceled)

180. (canceled)

181. (canceled)

182. (canceled)

183. (canceled)

184. (canceled)

185. The device of claim 170, wherein said request for potential transaction initiation including indicator of intent to carry out potential transaction receiving module comprises:
a request for potential transaction initiation generated in response to particular condition detection, including indicator of intent to carry out potential transaction receiving module.

186. The device of claim 185, wherein said request for potential transaction initiation generated in response to particular condition detection, including indicator of intent to carry out potential transaction receiving module comprises:
a request for potential transaction initiation generated in response to user-based particular condition detection, including indicator of intent to carry out potential transaction receiving module.

187. (canceled)

188. (canceled)

189. The device of claim 186, wherein said request for potential transaction initiation generated in response to user-based particular condition detection, including indicator of intent to carry out potential transaction receiving module comprises:
a request for potential transaction initiation generated in response to user-based location detection, including indicator of intent to carry out potential transaction receiving module.

190. The device of claim 170, wherein said request for potential transaction initiation including indicator of intent to carry out potential transaction receiving module comprises:
a request for potential transaction initiation including indicator of intent to carry out potential transaction receiving from a device that stores data regarding a user receiving module.

191. (canceled)

192. The device of claim 170, wherein said transaction data including request to utilize a particular payment channel for carrying out execution of at least a portion of the potential transaction acquiring module comprises:
a transaction data including request to utilize a particular payment channel for execution of at least a portion of the potential transaction receiving module.

193. The device of claim 192, wherein said transaction data including request to utilize a particular payment channel for execution of at least a portion of the potential transaction receiving module comprises:
a transaction data including request to utilize a particular payment modality for execution of at least a portion of the potential transaction receiving module.

194. The device of claim 193, wherein said transaction data including request to utilize a particular payment modality for execution of at least a portion of the potential transaction receiving module comprises:
a transaction data including request to utilize a particular payment modality of near-field communication equipped device proximity contact sensor for execution of at least a portion of the potential transaction receiving module.

195. (canceled)

196. (canceled)

197. The device of claim 170, wherein said transaction data including request to utilize a particular payment channel for execution of at least a portion of the potential transaction acquiring module comprises:
a transaction data including request to utilize a particular payment channel for execution of at least a portion of the potential transaction generating module.

198. (canceled)

199. The device of claim 170, wherein said transaction data including request to utilize a particular payment channel for execution of at least a portion of the potential transaction acquiring module comprises:
a particular data that is generated by a device associated with a user receiving module; and
a transaction data including the request to utilize a particular payment channel for carrying out at least a portion of the potential transaction generating at least partly based on the received particular data module.

200. (canceled)

201. (canceled)

202. The device of claim 199, wherein said particular data that is generated by a device associated with a user receiving module comprises:
a particular data about one or more properties of the device that is generated by the device associated with the user receiving module.

203. (canceled)

204. (canceled)

205. The device of claim 202, wherein said particular data about one or more properties of the device that is generated by the device associated with the user receiving module comprises:
a particular data about one or more device settings read by the device associated with the user receiving module.

206. The device of claim 170, wherein said transaction data including request to utilize a particular payment channel for execution of at least a portion of the potential transaction acquiring module comprises:
a transaction data that is part of the request for potential transaction initiation, said transaction data including request to utilize a particular payment channel for execution of at least a portion of the potential transaction acquiring module.

207. (canceled)

208. (canceled)

209. The device of claim 170, wherein said acquired particular payment channel absence from a set of one or more directly accepted payment channels determining module comprises:
an acquired particular payment channel including a particular payment modality absence from a set of one or more directly accepted payment channels determining module.

210. (canceled)

211. (canceled)

212. (canceled)

213. The device of claim 170, wherein said acquired particular payment channel absence from a set of one or more directly accepted payment channels determining module comprises:
an acquired particular payment channel including a particular payment option and a particular payment modality absence from a set of one or more directly accepted payment channels determining module.

214. The device of claim 170, wherein said acquired particular payment channel absence from a set of one or more directly accepted payment channels determining module comprises:
an acquired particular payment channel absence from a set of one or more payment channels not accepted when a particular condition is present determining module.

215. The device of claim 214, wherein said acquired particular payment channel absence from a set of one or more payment channels not accepted when a particular condition is present determining module comprises:
an acquired particular payment channel absence from a set of one or more payment channels not accepted when an unencrypted channel is used determining module.

216. (canceled)

217. (canceled)

218. The device of claim 170, wherein said acquired particular payment channel absence from a set of one or more directly accepted payment channels determining module comprises:
an acquired particular payment channel transmitting to an external resource module; and
a determination regarding absence of the acquired particular payment channel from the set of one or more directly accepted payment channels receiving module.

219. The device of claim 218, wherein said acquired particular payment channel transmitting to an external resource module comprises:
an acquired particular payment channel transmitting to an external resource selected at least partly based on one or more properties of the acquired particular payment channel module.

220. The device of claim 170, wherein said acquired particular payment channel absence from a set of one or more directly accepted payment channels determining module comprises:
a set of one or more directly accepted payment channels receiving module; and
an acquired particular payment channel to at least one of the payment channels present in the received set of one or more directly accepted payment channels comparing module.

221. (canceled)

222. (canceled)

223. The device of claim 170, wherein said facilitation of at least a portion of the potential transaction configured to provide an appearance of using the acquired particular payment channel to at least one party to the potential transaction negotiating module comprises:
a one or more resources designed to allow execution of at least a portion with an appearance of using the acquired particular payment channel to at least one party acquiring module.

224. The device of claim 170, wherein said facilitation of at least a portion of the potential transaction configured to provide an appearance of using the acquired particular payment channel to at least one party to the potential transaction negotiating module comprises:
an instruction to a user device to obtain transaction data at least partly using the acquired particular payment channel transmitting module;
an instruction to a user device to manipulate obtained transaction data into a format configured to be used with a further payment channel other than the particular payment channel transmitting module; and
a potential transaction facilitating at least partly using the further payment channel module.

225. The device of claim 224, wherein said instruction to a user device to obtain transaction data at least partly using the acquired particular payment channel transmitting module comprises:
an instruction to a user device to obtain transaction data at least partly using the acquired particular payment channel, so that an appearance of using the acquired particular payment channel to at least one party to the potential transaction is generated transmitting module.

226. (canceled)

227. (canceled)

228. The device of claim 224, wherein said potential transaction facilitating at least partly using the further payment channel module comprises:
a potential transaction facilitating at least partly using the further payment channel without providing notification to a user of the use of the further payment channel module.

229. The device of claim 170, wherein said facilitation of at least a portion of the potential transaction configured to provide an appearance of using the acquired particular payment channel to at least one party to the potential transaction negotiating module comprises:
a potential transaction facilitating at least partly using the further payment channel without providing notification to a user of the use of the further payment channel module; and
a data regarding the one or more determined resources transmitting to a user device configured to use the particular payment channel module.

230. The device of claim 229, wherein said potential transaction facilitating at least partly using the further payment channel without providing notification to a user of the use of the further payment channel module comprises:
a one or more resources configured to facilitate a first portion of the potential transaction using the particular payment channel and to facilitate a second portion of the potential transaction using a further payment channel that is present in the set of one or more directly accepted payment channels determining module.

231. The device of claim 230, wherein said one or more resources configured to facilitate a first portion of the potential transaction using the particular payment channel and to facilitate a second portion of the potential transaction using a further payment channel that is present in the set of one or more directly accepted payment channels determining module comprises:
a one or more devices configured to directly accept both the acquired particular payment channel and the further payment channel that is present in the set of one or more directly accepted payment channels determining module.

232. (canceled)

233. (canceled)

234. The device of claim 231, wherein said one or more devices configured to directly accept both the acquired particular payment channel and the further payment channel that is present in the set of one or more directly accepted payment channels determining module comprises:
a one or more devices having a particular property polling to determine at least one device configured to directly accept both the acquired particular payment channel and the further payment channel that is present in the set of one or more directly accepted payment channels module.

235. The device of claim 234, wherein said one or more devices having a particular property polling to determine at least one device configured to directly accept both the acquired particular payment channel and the further payment channel that is present in the set of one or more directly accepted payment channels module comprises:
a one or more devices having a particular location property polling to determine at least one device configured to directly accept both the acquired particular payment channel and the further payment channel that is present in the set of one or more directly accepted payment channels module.

236. (canceled)

237. The device of claim 234, wherein said one or more devices having a particular property polling to determine at least one device configured to directly accept both the acquired particular payment channel and the further payment channel that is present in the set of one or more directly accepted payment channels module comprises:
a one or more devices manufactured by a particular manufacturer polling to determine at least one device configured to directly accept both the acquired particular payment channel and the further payment channel that is present in the set of one or more directly accepted payment channels module.

238. The device of claim 170, wherein said facilitation of at least a portion of the potential transaction configured to provide an appearance of using the acquired particular payment channel to at least one party to the potential transaction negotiating module comprises:
a resource configured to facilitate at least a portion of the potential transaction configured to provide an appearance of using the acquired particular payment channel to at least one party to the potential transaction locating module; and
a located resource configured to facilitate at least the portion of the potential transaction assistance requesting module.

239. The device of claim 238, wherein said resource configured to facilitate at least a portion of the potential transaction configured to provide an appearance of using the acquired particular payment channel to at least one party to the potential transaction locating module comprises:
a resource configured to facilitate at least a portion of the potential transaction configured to provide an appearance of using the acquired particular payment channel to at least one party to the potential transaction locating at least partly based on a property of the acquired particular payment channel module.

240. (canceled)

241. The device of claim 170, wherein said facilitation of at least a portion of the potential transaction configured to provide an appearance of using the acquired particular payment channel to at least one party to the potential transaction negotiating module comprises:
an intermediary device having a particular property and configured to facilitate at least a portion of the potential transaction selecting module;
an agreement with the intermediary device to facilitate at least a portion of the potential transaction managing device; and
a data regarding the intermediary device transmitting to a user device associated with the at least one party to the potential transaction transmitting module.

242. (canceled)

243. The device of claim 241, wherein said intermediary device having a particular property and configured to facilitate at least a portion of the potential transaction selecting module comprises:
an intermediary device configured to interface with the acquired particular payment channel and to interface with a further payment channel present in the set of one or more directly accepted payment channels determining module selecting module.

244. The device of claim 241, wherein said intermediary device having a particular property and configured to facilitate at least a portion of the potential transaction selecting module comprises:
an intermediary device having a preexisting vendor agreement and configured to facilitate at least a portion of the potential transaction selecting module.

245. (canceled)

246. The device of claim 241, wherein said intermediary device having a particular property and configured to facilitate at least a portion of the potential transaction selecting module comprises:
an intermediary device having a particular application stored in memory and configured to facilitate at least a portion of the potential transaction selecting module.

247. The device of claim 241, wherein said agreement with the intermediary device to facilitate at least a portion of the potential transaction managing device comprises:
a compensation level for intermediary device to facilitate at least a portion of the potential transaction managing device setting module.

248. (canceled)

249. (canceled)

250. (canceled)

251. The device of claim 241, wherein said data regarding the intermediary device transmitting to a user device associated with the at least one party to the potential transaction transmitting module comprises:
an address of the intermediary device transmitting to the user device associated with the at least one party to the potential transaction transmitting module.

252. The device of claim 241, wherein said data regarding the intermediary device transmitting to a user device associated with the at least one party to the potential transaction transmitting module comprises:
an identity verification code used by intermediary device transmitting to the user device associated with the at least one party to the potential transaction transmitting module.

253-256. (canceled)
